(19) United States
(12) Patent Application Publication
(10) Pub. No.: US 2012/0110058 A1
(43) Pub. Date: May 3, 2012

(54) MANAGEMENT SYSTEM AND INFORMATION PROCESSING METHOD FOR COMPUTER SYSTEM

(75) Inventor: Keiichi Kuroda, Yokohama (JP)

(73) Assignee: HITACHI, LTD., Tokyo (JP)

(21) Appl. No.: 12/811,935

(22) PCT Filed: Apr. 22, 2010
(86) PCT No.: PCT/JP10/02929

§ 371 Date: Jul. 7, 2010

(51) Int. Cl. G06F 15/173

(52) U.S. Cl. 709/203

(57) ABSTRACT

A determination of whether or not an application is accessible is made on the basis of an evaluation result collected from a client terminal, and the determination result is provided to the client terminal. A client requests usage of an application to a management server and the management server compares information of the requested application with external security information, and on condition that there is no safety problem, the management server acquires the requested application from an application provider server, builds a safe application evaluation environment for the acquired application and provides this environment to the client, determines application accessibility by comparing the evaluation result from the client with an application accessibility rule, and sends the determination result to the client.

### TECHNICAL FIELD

The present invention relates to a management system and an information processing method for a computer system with which it is possible to perform management to ensure the safety of applications that are used by client terminals in enterprises and the like.

### BACKGROUND ART

Typically, in an information processing system that is built in an enterprise or the like, client terminals such as PCs (Personal Computers) used by each of the users in the organization are communicably interconnected with other client terminals via an on-site communication network so that the client terminals are each capable of receiving services provided by various servers on the Internet via a proxy server that is connected to the on-site communication network.

Meanwhile, the client terminals are also each capable of sending information, held by each of the client terminals, to the outside via an external communication network such as the Internet. For this reason, unless the information held by each client terminal is managed in each client terminal with security in mind, important information and so on will be leaked to the outside.

An arrangement has therefore been proposed whereby users of an internal system in an enterprise or the like are provided with e-education designed to ensure the security of the internal system, in accordance with the current status of each user terminal.

For example, an arrangement has been proposed whereby a management server for managing each of the user terminals collects environment information from each user terminal, determines management conditions for each user terminal based on the collected environment information and, depending on the management conditions, subjects the user terminals to a security-related e-education so that, among the user terminals on which the e-education is run, those user terminals not satisfying the management conditions are prohibited from executing programs other than programs determined beforehand (see PTL1).

Furthermore, there are currently a great number of applications on sites and so forth on the Internet, enabling users to use applications published on the Internet. These applications include applications that, when used in product development and business operation management and so on, enable development times to be shortened, high-quality products to be developed, or costs to be reduced.

However, this does not mean that all applications published on the Internet are safe or useful. Rather, such applications include those which are of low-quality and/or malicious. Use of such applications may generate a variety of problems such as the leakage of information or unauthorized access.

Currently, the leakage of information and unauthorized access are therefore typically prevented using the following methods.

(1) Application downloads from the Internet are prohibited.

(2) Only applications allowed by a system administrator (applications whose safety has been verified) are accessible.

(3) Prohibited applications such as file sharing software are made inaccessible.

### CITATION LIST

### Patent Literature

[PTL1] U.S. Patent Publication No. 2009-140472

### SUMMARY OF INVENTION

### Technical Problem

However, among these provisions, (1) or (2) also render inaccessible useful applications that are unverified, sometimes at the expense of user convenience and efficiency.

Moreover, since provision (3) does not restrict access to applications that are sometimes problematic, safety problems may arise when using applications other than file sharing software.

Hence, as a countermeasure to provisions (1) and (2), consideration may also be paid to a method in which users submit a request to use an application to a system administrator and the system administrator determines whether the application is accessible.

However, when confronted with the problem below, the system administrator is unable to swiftly determine accessibility for applications that users have requested, which reduces user convenience.

That is, when there is a small number of system administrators, these administrators are unable to devote sufficient time to investigating the safety of applications that users have requested and so on. Furthermore, since security-related information changes on a daily basis, it takes time for a system administrator to investigate the safety of applications that users have requested. Moreover, since there are a large number of applications on the Internet and new applications are released on an ongoing basis due to version changes and so on, the number of application requests is high.

The present invention was conceived in view of the problems faced by the aforementioned conventional technology, and an object of the present invention is to provide a management server and a computer system information processing method with which it is possible to build a safe application evaluation environment that is provided to client terminals, determine the accessibility of applications based on evaluation results collected from the client terminals, and provide the determination result to the client terminals.

### Solution to Problem

In order to achieve the above object, the present invention is characterized in that the management server builds a safe application evaluation environment that is provided to each of the client terminals, determines the accessibility of applications based on evaluation results collected from each of the client terminals, and provides the determination result to the client terminals.

### Advantageous Effects of Invention

According to the present invention, the management server is capable of building a safe application evaluation environment that is provided to client terminals, determining the accessibility of applications based on evaluation results collected from the client terminals and an application accessibility rule provided from the client terminals, and providing the determination result to the client terminals.

### BRIEF DESCRIPTION OF DRAWINGS

FIG. 1 A block configuration diagram of a computer system according to the present invention.

FIG. 2 An explanatory diagram providing an overview of processing of the computer system.

FIG. 3 A time chart illustrating processing to prime the computer system.

FIG. 4 A flowchart illustrating processing to create an app accessibility rule.

FIG. 5 A flowchart illustrating processing to create an app accessibility rule.

FIG. 6 A flowchart illustrating processing to create an app accessibility rule.

FIG. 7 A flowchart illustrating processing to create an app accessibility rule.

FIG. 8 A flowchart illustrating device authentication processing of a management server and a client.

FIG. 9 A configuration diagram of a management table.

FIG. 10 A time chart illustrating processing at application request timing, application download timing, and timing for building an evaluation environment.

FIG. 11 A flowchart illustrating app request processing.

FIG. 12 A flowchart illustrating app request processing.

FIG. 13 A flowchart illustrating app download processing.

FIG. 14 A flowchart illustrating app download processing.

FIG. 15 A flowchart illustrating app download processing.

FIG. 16 A flowchart illustrating app download processing.

FIG. 17 A flowchart illustrating app download processing.

FIG. 18 A flowchart illustrating app download processing.

FIG. 19 A flowchart illustrating app download processing.

FIG. 20 A flowchart illustrating processing to build the evaluation environment.

FIG. 21 A flowchart illustrating notification processing when building the evaluation environment.

FIG. 22 A flowchart illustrating notification processing when building the evaluation environment.

FIG. 23 A time chart illustrating processing at evaluation environment build completion timing, application operation/evaluation timing, and timing for collecting information other than evaluation information.

FIG. 24 A flowchart illustrating application operation/evaluation processing.

FIG. 25 A flowchart illustrating application operation/evaluation processing.

FIG. 26 A flowchart illustrating application operation/evaluation processing.

FIG. 27 A flowchart illustrating application operation/evaluation processing.

FIG. 28 A flowchart illustrating application operation/evaluation processing.

FIG. 29 A flowchart illustrating application operation/evaluation processing.

FIG. 30 A flowchart illustrating application operation/evaluation processing.

FIG. 31 A flowchart illustrating application operation/evaluation processing.

FIG. 32 A flowchart illustrating processing to acquire information other than the evaluation information.

FIG. 33 A flowchart illustrating processing to acquire information other than the evaluation information.

FIG. 34 A flowchart illustrating processing to acquire information other than the evaluation information.

FIG. 35 A time chart illustrating processing at the timing for collecting information other than the evaluation information, timing for updating an app accessibility list, and timing for deploying the app accessibility list.

FIG. 36 A flowchart illustrating processing to acquire information other than the evaluation information.

FIG. 37 A flowchart illustrating processing to acquire information other than the evaluation information.

FIG. 38 A flowchart illustrating processing to acquire information other than the evaluation information.

FIG. 39 A flowchart illustrating processing to acquire information other than the evaluation information.

FIG. 40 A flowchart illustrating processing to acquire information other than the evaluation information.

FIG. 41 A flowchart illustrating processing to acquire information other than the evaluation information.

FIG. 42 A flowchart illustrating processing to make a determination and update the app accessibility list.

FIG. 43 A diagram illustrating a display example of an app accessibility rule editing screen.

FIG. 44 A diagram illustrating a display example of an app request screen.

FIG. 45 A diagram illustrating a display example of an app selection screen.

FIG. 46 A diagram illustrating a display example of an app evaluation screen.

FIG. 47 A diagram illustrating a display example of an app evaluation result display screen.

### DESCRIPTION OF PREFERRED EMBODIMENTS

An embodiment of a system according to the present invention will be described hereinbelow. Note that, in the following description, information on the present invention will be described using expressions such as ‘aaa table,’ ‘aaa list,’ ‘aaaDB [database],’ and ‘aaa queue,’ but this does not necessarily mean that this information is restricted to being a table, a list, a DB [database], or a queue or similar. This information may also be expressed using another kind of data structure.

Hence, in order to show that there is no dependence on data structure, the ‘aaa table,’ ‘aaa list,’ ‘aaaDB,’ and ‘aaa queue’ and so on will sometimes be referred to as ‘aaa information.’

Furthermore, although, in describing the content of each information item, expressions such as ‘identification information,’ ‘identifier,’ ‘title,’ ‘name,’ and ‘ID’ are used, such expressions are interchangeable.

The subject of the following description may sometimes be ‘program.’ However, since predetermined processing is executed using memory and a communication port (communication controller) as a result of the program being run by the CPU, the subject of the following description may also be the CPU.

Furthermore, processing that is disclosed here with the program as the subject may actually be processing that is executed by a computer on which the program is run. In addition, some or all programs may be realized by dedicated hardware.

Moreover, various programs may also be installed on each computer by a program distribution server or storage media.

In the embodiment described hereinbelow, the management server builds a safe application evaluation environment that is provided to client terminals, and then determines the accessibility of applications based on evaluation results collected from the client terminals and on an application accessibility rule, and provides the determination result to the client terminals.

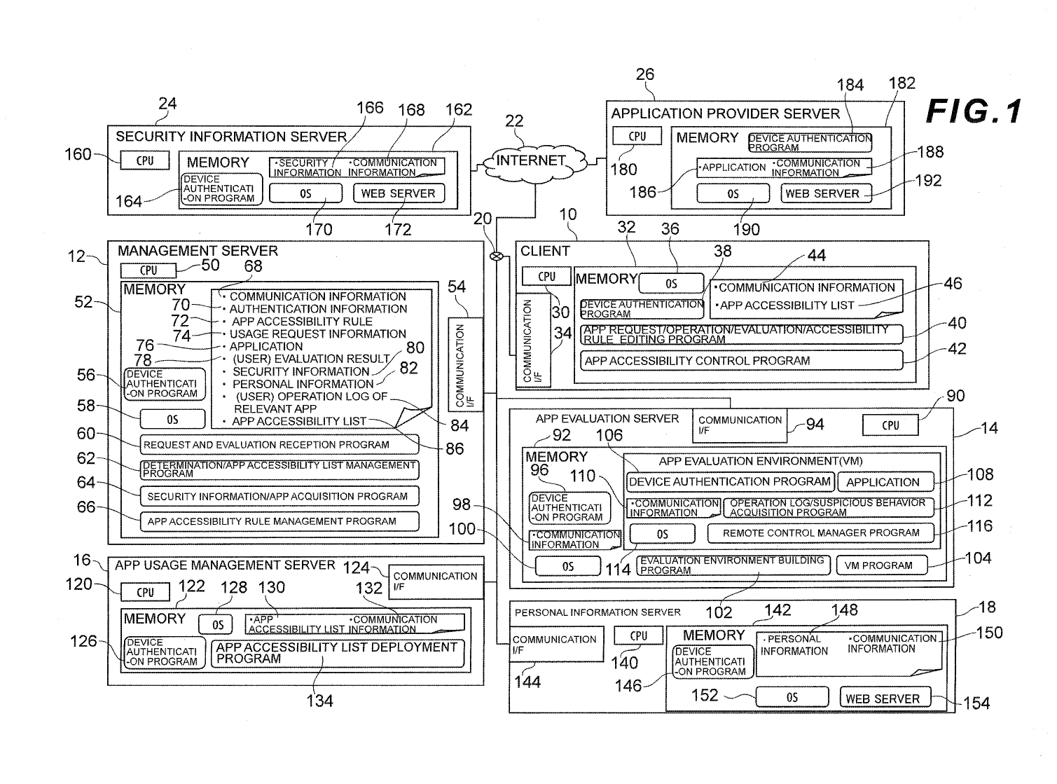

An embodiment according to the present invention will be described hereinbelow with reference to the drawings. FIG. 1 is a block configuration diagram of a computer system according to the present invention.

In FIG. 1, the computer system includes one or more client terminals (also referred to as clients hereinbelow) 10, a management server 12, an app evaluation server 14, an app usage management server 16, and a personal information server 18, and the servers are each coupled to one another via a network 20 such as a LAN (Local Area Network). The network 20 is coupled to a security information server 24 and an application provider server 26 via the Internet 22, which is a public telecommunication network. Note that an ‘app’ signifies an application and that applications will sometimes be referred to hereinbelow as ‘apps.’

The clients 10 include a CPU (Central Processing Unit) 30 as a processor for performing integrated control of all the clients 10, a memory 32, a communication interface (I/F) 34, an input device such as a mouse or keyboard (not shown), and an output device such as a display (not shown), and the communication network 34 is connected to the network 20. The memory 32 stores an OS (Operating System) 36, a device authentication program 38, an app request/operation/evaluation/accessibility rule editing program (sometimes referred to hereinbelow as an ‘editing program’) 40, an app accessibility control program 42, communication information 44, and an app accessibility list 46.

The CPU 30 executes various processing in accordance with the programs stored in the memory 32, and exchanges information with the other servers via the communication interface 34.

For example, the CPU 30 controls application execution permissions/denials on the basis of the app accessibility list 46 that is provided by the app usage management server 16. Furthermore, when a user using the client 10, for example, who submits a request to use an application published on the Internet 22 by a user within the organization, the CPU 30 performs processing to access the safe application evaluation environment. Thereafter, the user using the client 10 implements operation and evaluation of applications. Furthermore, when, among the users within the organization, the system administrator performs operations to create and edit a rule governing accessibility to the applications, the CPU 30 executes processing that corresponds to such operations.

Note that, among the users in the organization, a user requesting usage of an application is referred to as an ‘applicant,’ and a person who manages applications from applicants is known as a ‘system administrator.’

The communication information 44 comprises information that is used to communicate with and authenticate each server, for example. For example, the communication information 44 comprises ‘a device type for identifying each server,’ ‘a device IP address,’ which is an IP (Internet Protocol) address assigned to each server, a ‘device communication port number,’ which is a communication port number assigned to each server, and a ‘shared authentication key’ which is a shared key for authenticating each server.

Note that device types fall into two categories, namely, the management server 12 and the app evaluation server 14. Furthermore, the communication information 44 is not restricted to the aforementioned four information items; for example, the update date and time of each communication information item may also be used. In addition, when there is no need for mutual authentication between the servers, or when such authentication is impossible, the shared authentication key is not required. Where the authentication shared key is concerned, different keys may be used for each of the servers, or a shared key may be used for all the servers.

Furthermore, when, as the device type, an app evaluation environment (VM) is used in place of the app evaluation server, information on this device type is information whereby the client 10 connects to the app evaluation environment (VM) on the app evaluation server 14. If there are then one or more app evaluation environments, there is also a plurality of device type information. Furthermore, this device type information need not necessarily be held by the clients and may be excluded from the communication information 44; when the client 10 is connected to the app evaluation server 14, information relating to the app evaluation environment may also be received from the management server 12.

The app accessibility list 46 is a list describing the accessibility of each application in the client 10. This app accessibility list 46 is used when the CPU 30 starts up the app accessibility control program 42. Here, the CPU 30 controls application startup permissions or startup denials in accordance with the app accessibility control program 42.

The app accessibility list 46 records information for specifying applications, application accessibility information, and information such as an additions condition relating to application accessibility.

For example, as information for specifying applications, the application name (text editor A) or application executable file name (exe) is used. Furthermore, the application accessibility information used may be ‘accessible’ when an application is accessible and ‘inaccessible’ when application usage is not possible. Furthermore, the application accessibility-related additions condition that is used may be ‘accessible in segment xxx, xxx, xxx, xxx/24.’ As information for specifying applications, application version information, the application installation path, and the application executable file hash value may also be used.

Note that, in the following description, information relating to the present invention will be described using expressions such as application-related information, but this information may also be expressed using a data structure other than a table or the like. Hence, in order to show that there is no dependence on data structure, ‘application-related information’ and so on will sometimes be referred to simply as ‘information.’ Similarly also when a database is used, since a database data structure need not necessarily be provided, such information will sometimes be referred to simply as ‘information.’

Furthermore, although, in describing the content of each information item, expressions such as ‘identification information,’ identifier, ‘title,’ ‘name,’ and ‘ID’ are used, such expressions are interchangeable.

The subject of the following description may sometimes be ‘program.’ However, since predetermined processing is executed using the memory and communication port (communication controller) as a result of the program being executed by the processor, the subject of the following description may also be the processor. Furthermore, the processing disclosed here with the program as the subject may be processing that is executed by a computer or information processing device such as the management server 12. In addition, some or all programs may be realized by dedicated hardware. Moreover, the present invention need not necessarily be implemented using thread mechanisms, but rather may be implemented using any mechanism as long as execution is possible using mechanisms for managing the execution of programs provided by an OS Operating System such as micro-threads or other process mechanisms.

Moreover, various programs may also be installed on each computer by a program distribution server or storage media and so on.

Note that each server includes input/output devices. Examples of such input/output devices may include a display, a keyboard, and a pointing device but other devices are also possible.

Furthermore, as an alternative to these input/output devices, a serial interface or Ethernet interface may serve as an input/output device, and a display computer equipped with a display or keyboard or pointing device may be connected to the aforementioned interface so that display information is displayed on the display computer. By receiving inputs, a switch can be made between an input by the input/output device and the display.

The management server 12 includes a CPU 50 that performs integrated control of the whole management server, a memory 52, and a communication interface 54, and the communication interface 54 is connected to the network 20.

The memory 52 stores a device authentication program 56, an OS 58, a request and evaluation reception program 60, a determination/app accessibility list management program 62, a security information/app acquisition program 64, and an app accessibility rule management program 66. In addition, the memory 52 stores communication information 68, authentication information 70, an app accessibility rule 72, usage request information 74, an application 76, user evaluation results 78, security information 80, personal information 82, user app operation logs 84, and an app accessibility list 86.

The CPU 50 executes processing in accordance with the programs stored in the memory 52, and exchanges information with the other servers via the communication interface 54.

The CPU 50 executes processing to determine accessibility of the application 76 on the basis of the evaluation result 78 and the app accessibility rule 72 sent from the client 10.

At this time, the CPU 50 executes processing to receive an app application request sent from the client 10 and the evaluation result 78 sent from the client 10, and executes the displaying of an accessibility determination result for the application 76, and notification of information to the client 10. In addition, the CPU 50 executes creation processing and editing processing relating to the app accessibility rule 72 sent from the client 10. Furthermore, the CPU 50 uses the security information 80, the personal information 82, and the app operation log 84 to determine the accessibility of the application 76, and therefore executes processing to acquire information from other servers and applications published on the Internet 22.

At this time, upon acquiring applications published on the Internet 22, the CPU 50 executes processing to check whether an application requested by the client 10 is on a safe site based on external security information.

Furthermore, the CPU 50 makes a determination of the accessibility of the application 76 based on the evaluation result 78 sent from the client 10 and the security information 80 acquired from outside and so on and, based on the determination result, executes processing to notify the client 10 of updates to the app accessibility list 86 as well as information relating to the app accessibility list 86.

Information of an identical composition to the communication information 44 in the client 10 may be used as the communication information 68 in the management server 12. Note that four categories may be used as the device types in the communication information 68, namely, the app usage management server 16, the app evaluation server 14, the security information server 34, and the personal information server 18. Furthermore, if other items are required, the device name (server name), and the update date and time of each communication information item may also be used, for example.

The authentication information 70 is information used to discriminate and authenticate a system administrator and is used prior to creating and editing the app accessibility rule 72.

As an example of the authentication information 70, a ‘user ID,’ and a ‘password’ may be used as information for checking whether someone is a system administrator.

The app accessibility rule 72 is information that is used to allow the management server 12 to determine the accessibility of the application requested by the client 10. The app accessibility rule 72 is information that is created beforehand by the system administrator using the client 10 and stored in the memory 52 after being received from the client 10, and is edited where necessary.

Furthermore, as information that appears in the app accessibility rule 72, ‘a condition for allowing application downloads’ and ‘conditions for allowing application usage’ are used, for example.

‘Conditions for allowing application downloads’ refers to the fact that information pertaining to the safety of a site hosting an application must satisfy the following conditions.

(1) The risk level evaluation result for the URL of the site hosting the application is safe or caution.

‘Conditions for allowing application usage’ refers to the fact that the evaluation result must satisfy the following conditions.

(2) A valid evaluation result is returned by 30% or more of all users in the organization.

(3) In an evaluation aspect conducted by the users, users responding YES (response when there is a problem) no more than once are fewer than half of the responding users.

(4) In an evaluation aspect conducted by the users, among the users responding YES at least twice and no more than five times, ‘high’ does not occur in the app operation log or personal information.

Incidentally, a ‘high’ condition in the app operation log means five or more app startups and the app execution time is at least 30 minutes, and the ‘high’ condition in personal information denotes a job position of section manager or higher.

For security information, the following conditions are satisfied.

(1) There should be no instances of suspicious behavior in any application behavior.

(2) In the application vulnerability information, the vulnerability evaluation result for the application is safe or caution.

Note that the app accessibility rule 72 is not restricted to the example above, and the number of conditions may be configured freely at a larger or smaller number. Moreover, the app accessibility rule 72 describes a single rule for all the applications in the above example, but may also be configured individually for each application.

The determination/app accessibility list management program 62 executes processing to make a determination for each application based on the aforementioned conditions before the application is downloaded or when an evaluation by a user has started.

Of the usage request information 74 and the application 76, the usage request information 74 is application-related information that is input to the client 10 by an applicant when submitting a request. The application 76 is information for specifying an application body acquired from a server on the Internet 22 on the basis of the information input by the applicant when the application is requested.

The usage request information 74 comprises an ‘application name’ and an ‘application URL,’ for example, to which the application 76 is added as information for storing the application body.

Note that, as information relating to the requested application, the application type, the application version information, the manufacturer's name (operator's name) and an indication of whether the application is paid or free may also be used.

The (user) evaluation result 78 denotes information indicating the result of an evaluation of each application as performed by each user using the client 10. Each user using the client 10 actually operates the application with respect to the evaluation aspect presented by the management server 12 and, by notifying the management server 12 of the operation result, the operation result is stored in the memory 52 as the evaluation result 78.

The evaluation result 78 contains the evaluation aspect conducted by the user and information relating to comments on the relevant application.

Examples of the evaluation aspects conducted by the user that may be used include items such as ‘a large volume of error messages or error dialogs are displayed during operation,’ ‘an interface for the entry of personal information and/or a PIN is displayed,’ and ‘slanderous or other such inappropriate messages are displayed.’

Users respond to these items with ‘YES” when an item applies or ‘NO’ when an item does not apply. Furthermore, ‘comments on the relevant application’ refers to cases where users record their impressions when operating and evaluating the application in question, for example, and if there is nothing recorded in the comment field, the comment field is blank.

Note that the date and time the evaluation was performed and so on, for example, may also be added as a further item to the evaluation aspect conducted by the user.

Furthermore, a method may be adopted whereby when, for each item of the evaluation aspect conducted by the user, a user operation is discerned, the extent to which the user operation is a problem is recorded as 0 (minimum) up to 100 (maximum), 0 being recorded when no such user operation is performed.

Furthermore, the security information 80 is information relating to application safety that is collected in the computer system or outside the computer system (on the Internet). This security information 80 is information collected by the management server 12 from the corresponding server at regular intervals or where necessary.

The security information 80 comprises application vulnerability information, information pertaining to the safety of a site where an application exists, and suspicious behavior of an application.

The application vulnerability information comprises information for specifying an application and from the vulnerability level, for example.

The information for specifying an application comprises an ‘application name’ and ‘version,’ and the vulnerability level comprises the ‘vulnerability evaluation result.’ The ‘vulnerability evaluation result’ used may be ‘emergency,’ ‘warning,’ ‘safe,’ or ‘caution,’ for example.

The information relating to the safety of the site hosting the application comprises information for specifying the site and from the risk level, for example. The information for specifying the site comprises a ‘site URL’ and the risk level comprises a ‘risk level evaluation result.’ Depending on this level, the ‘risk level evaluation result’ used may be ‘risky,’ ‘warning,’ ‘safe,’ or ‘caution.’

Suspicious behavior of an application comprises information for specifying the application and a list of suspicious behavior.

The information for specifying an application comprises an ‘application name’ and ‘version.’ The list of suspicious behavior comprises the ‘number of outbound file transfers,’ ‘the number of inbound file transfers,’ and ‘the number of accesses to other machines.’

Note that the latest update date and time and the name of the site providing information and so on may also be used as application vulnerability information.

Furthermore, as information for specifying applications, the manufacturer's name (author's name), the executable file hash value, the assumed environment (for example, vulnerability is actualized only on a certain OS) may also be used.

In addition, the vulnerability level used may be, for a plurality of evaluation aspects rather than a single evaluation aspect, the severity of an attack, the attack path, the affected range, and so forth. Furthermore, the information displayed on the browser title may be used as information for specifying the site, and the number of writes to the system area and the number of times mail and messages are sent/received may be used to recognize suspicious behavior.

The personal information 82 is information relating to the positions within the organization of the users using the client 10 and the skills each user possesses. This personal information 82 is used to verify the reasonability of the evaluation conducted by each user. The management server 12 acquires the personal information 82 at regular intervals or as necessary from the personal information server 18 in the organization.

The personal information 82 comprises information for specifying the user and personal information of the user. The information for specifying the user comprises a ‘user name’ and the personal information of the user comprises the [user's] ‘position,’ for example. ‘Department manager,’ ‘section manager,’ ‘director,’ and ‘employee’ may be used as ‘positions.’ Furthermore, the qualifications held by the user and the operating history (information on the development of similar applications in the past and so on) may be used as the user's personal information.

The (user) app operation log 84 is operation log information for the application run by each user using the client 10. This app operation log 84 is used to verify the reasonability of the evaluation conducted by each user.

The app operation log 84 comprises information for specifying the user, information for specifying the application, and application operations information.

The information for specifying the user comprises the ‘user name,’ the information for specifying the application comprises the ‘application name,’ and the application operations information comprises the ‘app startup count,’ and the ‘app execution time.’

An employee number and a mailing address may also be used as information for specifying the user. In addition, as information for specifying the application, application version information, the application executable file name or hash value, and the application installation path may also be used. Moreover, information that may be used as the application operation information includes a final startup date and time, and the number of times an operation is performed on (an input is made to) the application from input devices such as a keyboard and mouse.

Furthermore, where the operation log is concerned, if when the app evaluation server 14 sends the acquired operation log information, data in a different format from the operation log format is transferred to the management server 12 in the following format, for example, the management server 12 is able to add together the received operation logs and convert these operation logs into the operation log format. That is, if ‘startup time’ is sent instead of ‘app startup count’ or ‘app execution time,’ the management server 12 is also capable of conversion to ‘app startup count’ or ‘app execution time’ based on the ‘startup time.’

The app evaluation server 14 includes a CPU 90 that performs integrated control of the whole app evaluation server, a memory 92, and a communication interface 94, and the communication interface 94 is connected to the network 20.

The memory 92 stores a device authentication program 96, communication information 98, an OS 100, an evaluation environment building program 102, and a VM (Virtual Machine) program 104. Furthermore, the memory 92 stores, as information for building an app evaluation environment (VM), a device authentication program 106, an application 108, communication information 110, an operation log/suspicious behavior acquisition program 112, an OS 114, and a remote control manager program 116.

The CPU 30 executes various processing in accordance with the programs stored in the memory 92, and exchanges information with the other servers via the communication interface 94.

For example, the CPU 90 executes the following processing as processing to provide the users using the client 10 with an environment for operating an application.

(1) Building of an evaluation environment (including the introduction of an application to the environment thus built)

(2) Acquisition of a user operation log (used for the reasonability of the user's evaluation)

(3) Acquisition of suspicious behavior of each app.

As a result of the CPU 90 executing the aforementioned processing, the app evaluation server 14 then functions as a server for providing the client 10 with an environment for operating the application.

Note that the app evaluation server 14 holds information such as the operation logs temporarily until this information is sent to the management server 12, deleting the operation logs and other information after they are sent.

The communication information 110 in the app evaluation server 14 is of an identical composition to the communication information 44 in the client 10. Note that the device type in the communication information 110 falls into two categories, namely, the management server 12 and the client 10.

In the app evaluation server 14, an environment in which safety is secured is an environment based on the idea of a sandbox, and corresponds to a virtual PC or similar built on VM software. The app evaluation environment is not limited to a single environment, rather there may be one or more such environments.

The operation log/suspicious behavior acquisition program 112 is a program with a function for acquiring operations of applications being evaluated, and this program may be in the client 10.

The app usage management server 16 includes a CPU 120 that performs integrated control of the whole app usage management server 16, a memory 122, and a communication interface 124, and the communication interface 124 is connected to the network 20.

The memory 122 stores a device authentication program 126, an OS 128, an app accessibility list 130, communication information 132, and an app accessibility list deployment program 134.

The CPU 120 executes various processing in accordance with the programs stored in the memory 122, and exchanges information with the other servers via the communication interface 124.

The app usage management server 16 manages the app accessibility list 130 and is configured as a server for deploying the app accessibility list 130 for the client 10.

The app accessibility list 130 is of an identical composition to the app accessibility list 46 in the client 10, and the communication information 132 is of an identical composition to the communication information 44 in the client 10.

Note that two categories, namely, the management server 12 and the client 10, are used for the device type in the communication information 132.

The personal information server 18 includes a CPU 140 that performs integrated control of the whole personal information server, a memory 142, and a communication interface 144, and the communication interface 144 is connected to the network 20.

The memory 142 stores a device authentication program 146, personal information 148, communication information 150, an OS 152, and a Web server (Web server program) 154.

The CPU 140 executes processing in accordance with the device authentication program 146 stored in the memory 142, and exchanges information with the other servers via the communication interface 144.

The personal information 148 is reference information of the management server 12 and of an identical composition to the personal information 82. The communication information 150 is of an identical composition to the communication information 44 in the client 10. Note that there is one category for the device type in the communication information 150, namely, the management server 12. If the personal information server 18 does not require mutual authentication with the management server 12, the communication information 150 is unnecessary.

In addition, the personal information server 18 is not limited to a single server, rather there may be one or more of such servers. In this case, this does not mean, however, that all the personal information 82 that exists on the management server 12 exists as personal information 148 on a personal information server 18 in one location.

The security information server 24 includes a CPU 160 that performs integrated control of the whole security information server 24, and a memory 162, and the communication interface (not shown) is connected to the Internet 22.

The memory 162 stores a device authentication program 164, security information 166, communication information 168, an OS 170, and a Web server (Web server program) 172.

The CPU 160 executes device authentication processing in accordance with the device authentication program 164 stored in the memory 162, and exchanges information with the other servers via the Internet 22.

The security information server 24 is a server that discloses security information over the Internet 22 (this server also includes a server accessible only to those with a paid contract), and discloses vulnerable application information and so on, for example. Examples of specific servers include servers of sites publishing public vulnerability information such as CVE, CPCERT/CC, and JVN, or of sites of various antivirus vendors and companies publishing applications, for example.

In addition, the security information server 24 is not limited to a single server, rather there may be one or more of such servers. In this case, the security information 80 that exists on the management server 12 is information acquired from each security information server 24. Moreover, the communication information 168 is of an identical composition to the communication information 44 in the client 10. There is one category for the device type in the communication information 168, namely, the management server 12. If the security information server 24 does not require mutual authentication with the management server 12, the communication information 168 is unnecessary.

The application provider server 26 includes a CPU 180 that performs integrated control of the whole application provider server, a memory 182, and a communication interface (not shown), and the communication interface is connected to the Internet 22.

The memory 182 stores a device authentication program 184, an application 186, communication information 188, an OS 190, and a Web server (Web server program) 192.

The CPU 180 executes device authentication processing in accordance with the device authentication program 184 stored in the memory 182, and exchanges information with the other servers via the Internet 22.

There are one or a plurality of the application provider server 26, and when a plurality of application provider servers 26 exist on the Internet 22, an application is then provided to the management server 12 from either application provider server 26.

The communication information 188 is of an identical composition to the communication information 44 in the client 10. There is one category for the device type in the communication information 188, namely, the management server 12. If the application provider server 26 does not require mutual authentication with the management server 12, the communication information 188 is unnecessary.

The application provider server 26 is a server for publishing applications on the Internet 22, and when the management server 12 or client 10 accesses the application provider server 26, the application 186 of the application provider server 26 is downloaded to the management server 12.

Applications published on the Internet 22 are programs with various functions, and accessibility control is performed in the app usage management server 16.

According to this embodiment, the management server 12, app evaluation server 14 and app usage management server 16 are arranged separately but the app evaluation server 14 and app usage management server 16 are integrated into the management server 12, and the management server 12 may also be configured as a server with the functions of the app evaluation server 14 and the app usage management server 16.

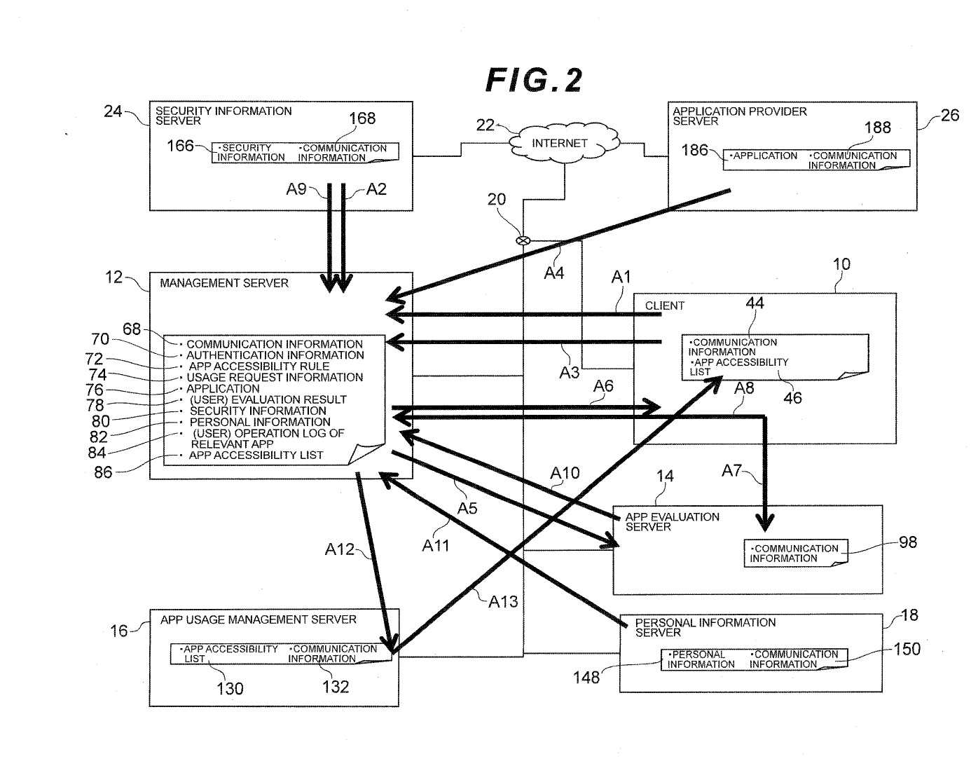

An overview of the processing of the computer system will be described next with reference to FIG. 2. First, assuming that the system administrator operates the client 10 and performs an operation to create an app accessibility rule and to send the app accessibility rule thus created, the information of the app accessibility rule is sent to the management server 12 from the client 10 (A1). Furthermore, the management server 12 collects security information 166 from the external security information server 24 at regular intervals and stores this information as security information 80 (A2). The following processing is subsequently performed.

(1) If there is an application that the applicant (user) would like to use, he or she operates the client 10 to submit a usage request to the management server 12 (A3). In so doing, the applicant submits information to the management server 12 such as the URL (Uniform Resource Locator) indicating the site hosting the application without downloading the application itself.

(2) The management server 12 downloads the application from the application provider server 26 based on the URL or other information after receiving the application request (A4). In so doing, the management server 12 uses the acquired security information 80 to verify whether or not the URL is a safe site, and stops downloading the application if there is a problem.

(3) The management server 12 asks the app evaluation server 14 to build a safe application evaluation environment (A5).

(4) Upon receiving information to the effect that a safe application evaluation environment has been built from the app evaluation server 14, the management server 12 notifies all the clients 10 that the requested application can be evaluated and publishes information to the effect that the requested application can be evaluated (A6).

(5) Based on the information submitted in (4), the user using the client 10 accesses the safe app evaluation environment built by the app evaluation server 14 (A7), runs the application and conducts an evaluation, and sends the evaluation result to the management server 12 (A8).

(6) In the course of (5), the management server 12 collects the latest security information from the security information server 24 (A9), collects a user operation log for the relevant application as well as any suspicious behavior of the application from the app evaluation server 14 (A10), and collects the user's personal information from the personal information server 18 (A11).

(7) The management server 12 compares the information collected in (5) and (6) with the app accessibility rule 72 to determine the accessibility of the application, and updates the app accessibility list 86 in accordance with the determination result.

(8) The management server 12 sends the updated app accessibility list 86 to the app usage management server 16 (A12) and the app usage management server 16 distributes the updated app accessibility list 130 to each of the clients 10 (A13).

A notice regarding the accessibility of the applications in the clients 10 is accordingly issued to the clients 10. Here, when a notice is received that an application can be used, the user using the client 10 is able to use the application, and when a notice is received that application usage is not possible, the user using the client 10 is unable to use the application.

By performing the aforementioned processing, when allowing usage of an application, a system administrator using the client 10 does not carry out the work of receiving a request, investigating and evaluating an application, or permitting usage, thereby reducing the work load. Furthermore, the user using the client 10 is able to evaluate the application easily and safely since the safe environment that is required to evaluate the application is prepared automatically.

In addition, should a problem arise in using the information collected from internal and external sources prior to building the app evaluation environment or determining the app accessibility, the management server 12 stops subsequent processing and therefore work costs can be reduced without the system administrator and users performing extra work.

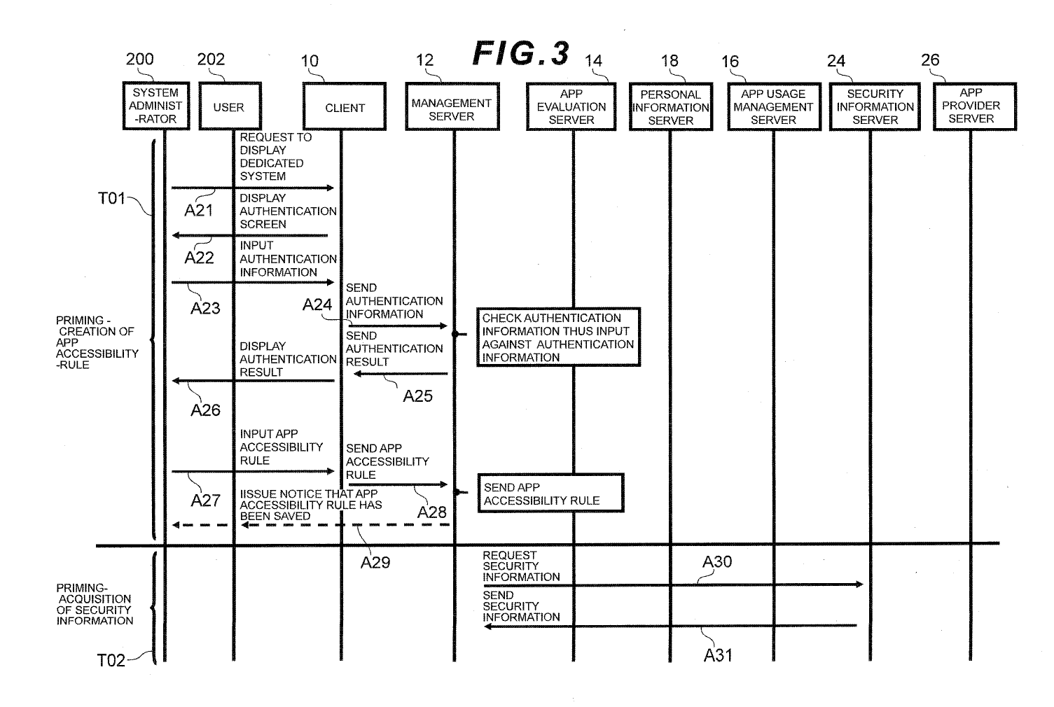

The process flow during priming is shown next in FIG. 3.

When performing priming, the client 10 and the management server 12 are configured with timing T01 for creating the app accessibility rule and timing T02 for collecting security information.

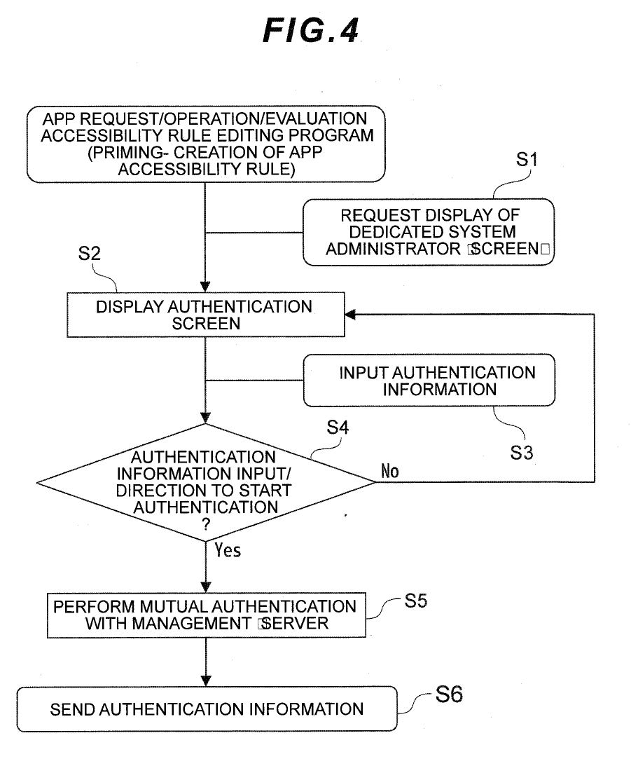

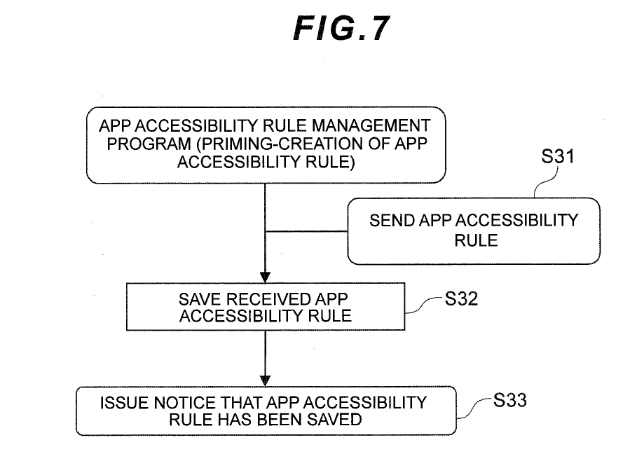

The processing during priming will be explained hereinbelow in accordance with the time chart in FIG. 3 and the flowcharts of FIGS. 4 to 8.

First, at timing T01 for creating the app accessibility rule, the app request/operation/evaluation/accessibility rule editing program 40 is started up by the CPU 30 and the processing is started, as shown in FIG. 3. Here, when a request to display a dedicated system administrator screen is issued to the client 10 by the system administrator 200 (A21), the client 10 displays the authentication screen (A22). When a system administrator 200 performs an authentication information input operation on the authentication screen (A23), the client 10 performs mutual authentication processing with the management server 12, and on condition that authentication is successful, sends authentication information to the management server 12 (A24).

Here, in the management server 12, the authentication information thus input is compared with the authentication information 70 stored in the memory 52 and processing to confirm the authentication information is executed.

The management server 12 then sends the authentication result to the client 10 (A25) and the client 10 executes an authentication result display for the system administrator 200 (A26). The client 10 then determines whether the authentication result is successful, and when the authentication result is successful, performs processing to display the authentication result to the system administrator 200, and receives an input of the app accessibility rule from the system administrator 200 (A27).

The client 10 then sends the app accessibility rule to the management server 12 (A28) and the management server 12 saves the received app accessibility rule in the memory 52. The management server 12 then notifies the client 10 and the system administrator 200 that the app accessibility rule has been saved (A29).

Meanwhile, at timing T02 for acquiring security information during priming, a request for the security information is made to the security information server 24 by the management server 12 (A30) and the security information is sent to the management server 12 from the security information server 24 (A31).

The processing at timing T01 for creating the app accessibility rule during priming will be explained next with reference to the flowchart in FIG. 4.

At timing T01 for creating the app accessibility rule, the app request/operation/evaluation/accessibility rule editing program 40 is started up by the CPU 30 and the processing is started. Here, when a request to display a dedicated system administrator screen is made by the system administrator 200 to the client 10 (S1), the client 10 displays the authentication screen (S2).

When the system administrator 200 performs an authentication information input operation to the authentication screen, the client 10 receives authentication information (S3), makes a determination of whether there is a direction to start the authentication (S4), returning to the processing of step S2 when there is no direction to start the authentication, and performing mutual authentication processing with the management server 12 when there is a direction to start the authentication (S5), and on condition that authentication is successful, sends authentication information to the management server 12 (S6).

Here, in the management server 12, the authentication information thus input is compared with the authentication information 70 stored in the memory 52 and processing to confirm the authentication information is executed.

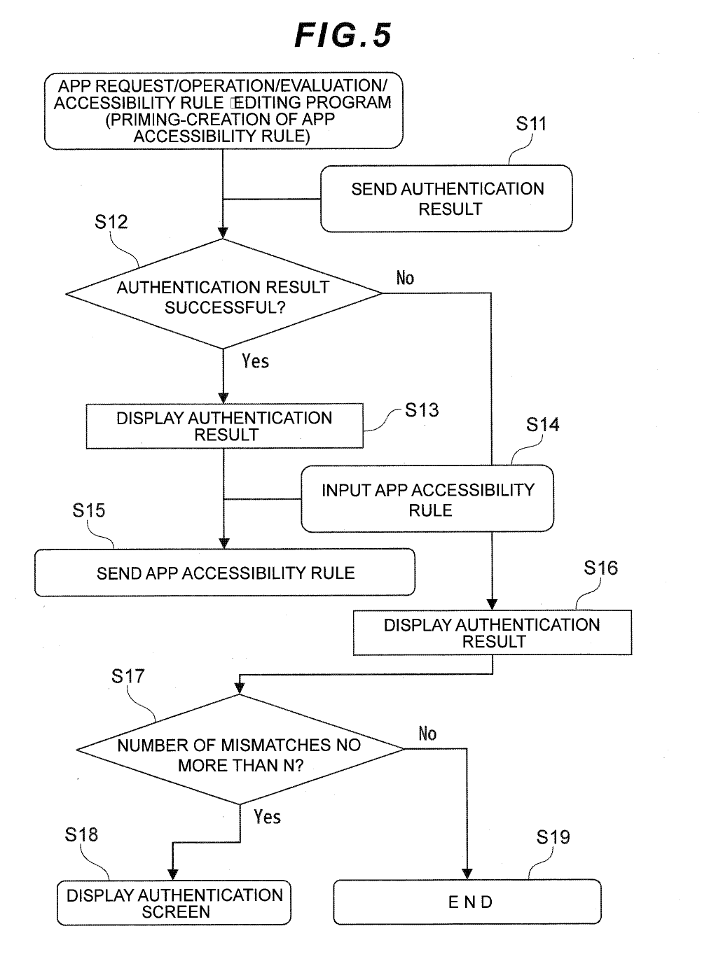

As shown in FIG. 5, the management server 12 then sends the authentication result to the client 10 (S11) and the client 10 executes an authentication result display for the system administrator 200. At this time, the CPU 30 in the client 10 determines whether the authentication result is successful (S12) and, when the authentication result is successful, performs processing to display the authentication result to the system administrator 200 (S13), and receives an input of the app accessibility rule from the system administrator 200 (S14).

The CPU 30 then sends the app accessibility rule to the management server 12 (S15) and the management server 12 saves the received app accessibility rule in the memory 52.

On the other hand, when it is determined in step S12 that the authentication result is failure, the CPU 30 displays an authentication failure message on the dedicated system administrator screen as an authentication result display (S16) and determines whether or not the number of mismatches is no more than N (S17). Note that N is an integer representing a permissible number of failures.

When the number of mismatches is determined to be no more than N, the CPU 30 displays a message to that effect on the authentication screen (S18), and when the number of mismatches is determined to exceed N, this signifies an error since the permissible number of failures has been exceeded, and the CPU 30 terminates the processing (S19).

Note that taking the number of mismatches N as the threshold, the processing is terminated if the number of mismatches exceeds N, and up until that point a screen for re-inputting authentication information can also be displayed.

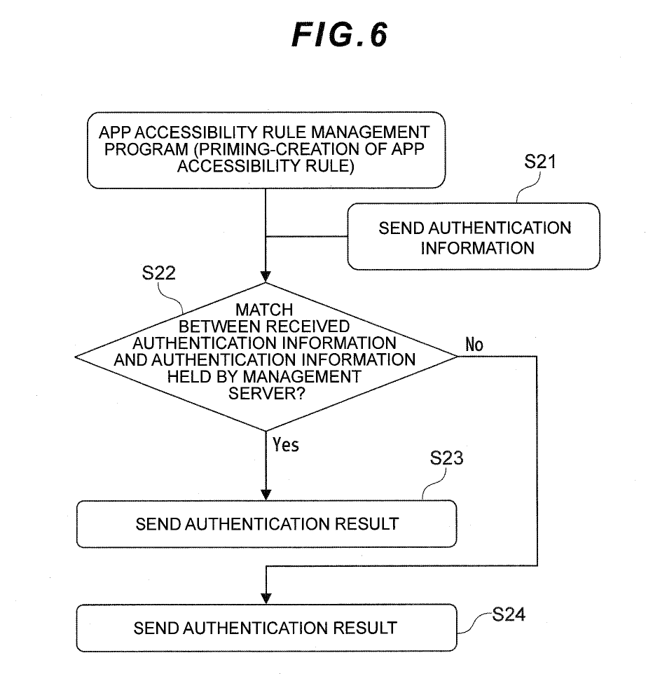

Furthermore, at timing T01 for creating the app accessibility rule during priming, when, as shown in FIG. 6, the app accessibility rule management program 66 in the management server 12 is started up by the CPU 50 and authentication information is sent to the management server 12 from the client 10 (S21), the CPU 50 determines whether or not the received authentication information matches the authentication information 78 held by the management server 12 (S22); when it is determined that the two information items match, the CPU 50 sends a successful authentication result to the client 10 (S23) but when it is determined that the two information items do not match, the CPU 50 sends an authentication result to the client 10 to the effect that authentication has failed (S24).

Furthermore, when an app accessibility rule is sent from the client 10 (S31), the CPU 50 in the management server 12 saves the received app accessibility rule in the memory 52 as an app accessibility rule 72 (S32, A28), and notifies the client 10 and the system administrator 200 that the app accessibility rule has been saved (S33).

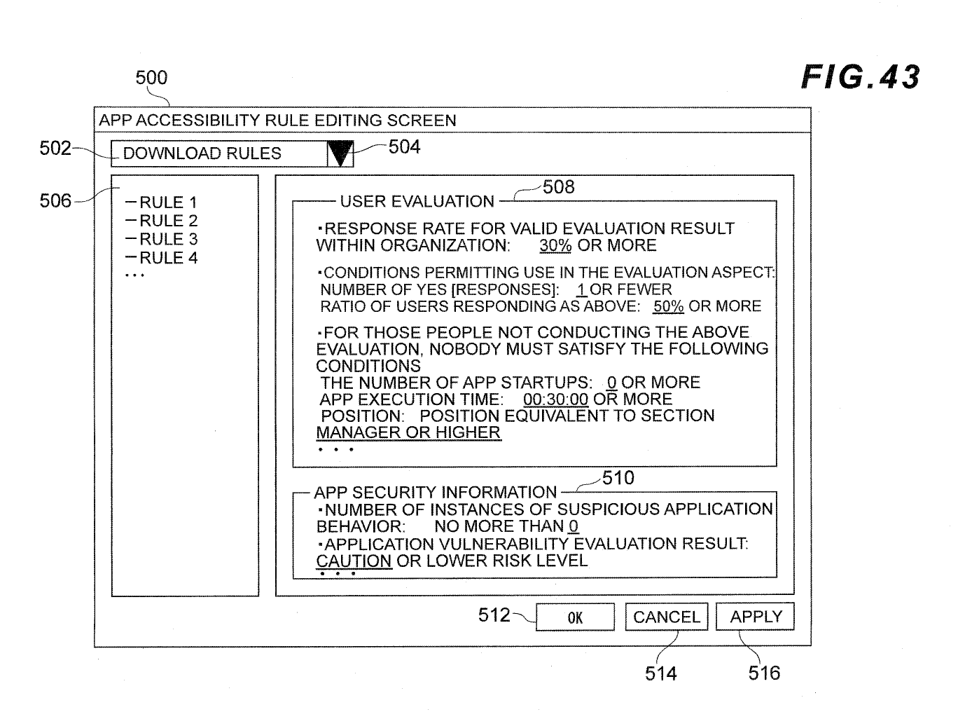

FIG. 43 shows a display example of an app accessibility rule editing screen 500. The app accessibility rule editing screen 500 includes a download rule display area 502, a pull-down menu selection area 504, a rule display area 506, a user evaluation display area 508, an app security display area 510, an OK button 512, a cancel button 514, and an apply button 516.

By manipulating the pull-down menu display area 504, the user displays a list of application download rules and application accessibility rules and so on. By then selecting a rule from the rule display area 506, the content of these rules is displayed.

The user display area 508 displays ‘30% or more,’ for example, for the ‘response rate for valid evaluation results within the organization’, and for the ‘conditions permitting use in the evaluation aspect,’ the number of YES responses' is displayed as ‘one or fewer,’ for example, and the ‘ratio of users responding as above’ is displayed as ‘50% or more,’ for example. Moreover, for ‘for those people not conducting the above evaluation, nobody must satisfy the following conditions,’ the conditions displayed are ‘the number of app startups’ is ‘0 or more,’ the ‘app execution time’ is ‘00:30:00 or more,’ and ‘the position’ is ‘a position equivalent to section manager or higher.’

The app security information display area 510 displays, for example, ‘the number of instances of suspicious application behavior’ is ‘no more than 0,’ and the ‘application vulnerability evaluation result’ is ‘caution’ or a lower risk level.

Furthermore, the app security information display area 510 displays a list of configurable app accessibility rules. Here, values are configured in the underlined parts (candidate selection format) for each of the items to be configured.

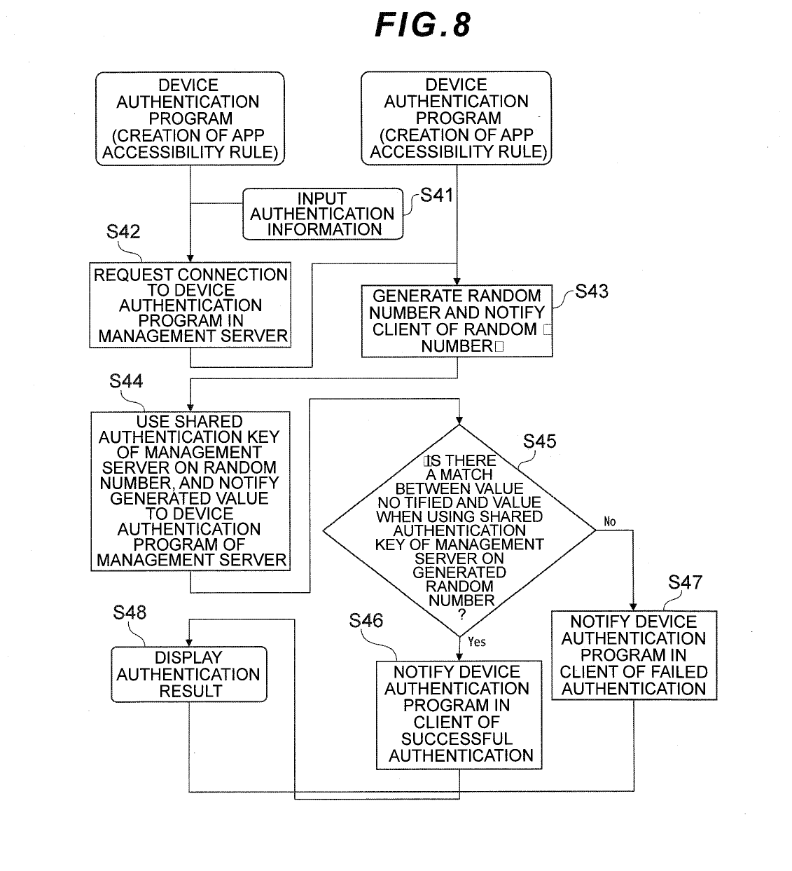

The device authentication processing of the management server 12 and client 10 will be explained next with reference to the flowchart of FIG. 8. During this processing, in the client 10, the device authentication program 38 is started up by the CPU 30 and, in the management server 12, the device authentication program 56 is started up by the CPU 50.

First, the CPU 30 in the client 10 inputs authentication information (S41) and requests connection to the device authentication program 56 in the management server 12 (S42), and the management server 12 generates a random number and notifies the random number to the client 10 (S43).

The CPU 30 of the client 10 uses a shared authentication key of the management server 12 on the random number and notifies the device authentication program 52 of the management server 12 of the value generated (S44).

The CPU 50 of the management server 12 uses the shared authentication key of the management server 12 on the generated random number and determines whether or not the value matches the notified value (S45); when it is determined that these values match, the CPU 50 notifies the device authentication program 38 of the client 10 regarding successful authentication (S46), and when it is determined that the two values do not match, the CPU 50 notifies the device authentication program 38 of the client 10 that authentication has failed (S47).

Thereafter, the CPU 30 of the client 10 determines the authentication result from the management server 12 and displays the authentication result (S48).

The above processing describes an example where the client 10 and the management server 12 execute device authentication using the challenge & response method but device authentication can be performed not only between the client 10 and the management server 12 but also with different servers from the management server 12 such as the app usage management server 16, for example. In this case, a program for performing mutual authentication of each device is installed in each device.

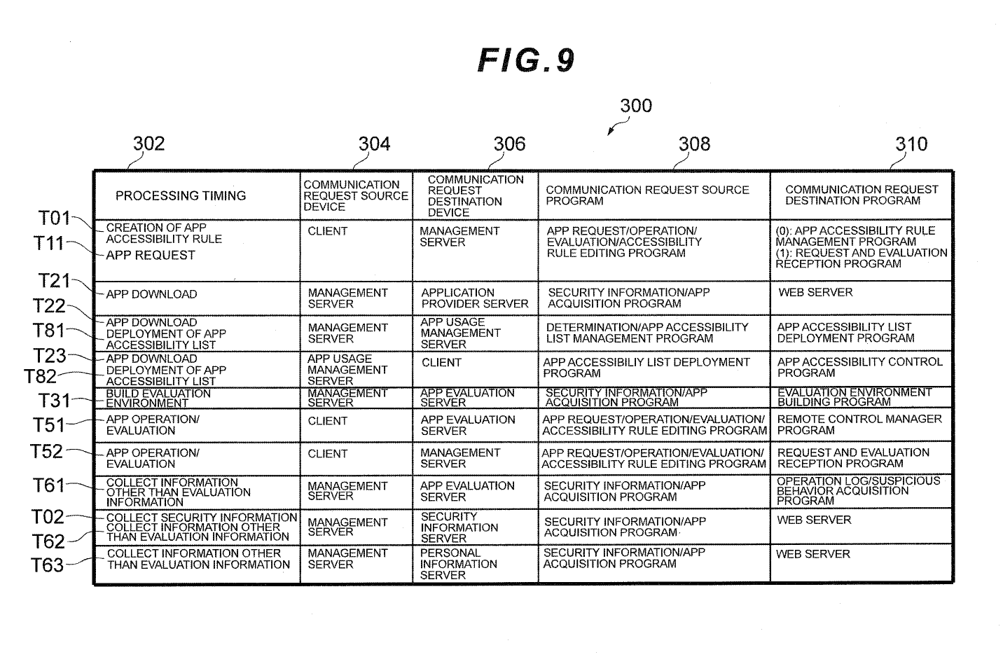

FIG. 9 then shows the configuration of the management table 300. In FIG. 9, as processing timing 302, timing T01 for creating the app accessibility rule and timing T02 for collecting security information are configured at the priming stage; the client 10 and the management server 12 are used as notification request source devices 304; the management server 12 and the security information server 24 are used as communication request destination device 300; the app request/operation/evaluation/accessibility rule editing program 40 and the security information app acquisition program 64 are used as a communication request source program 308; and the app accessibility rule management program 66 and the Web server 172 are used as a communication request destination program 310.

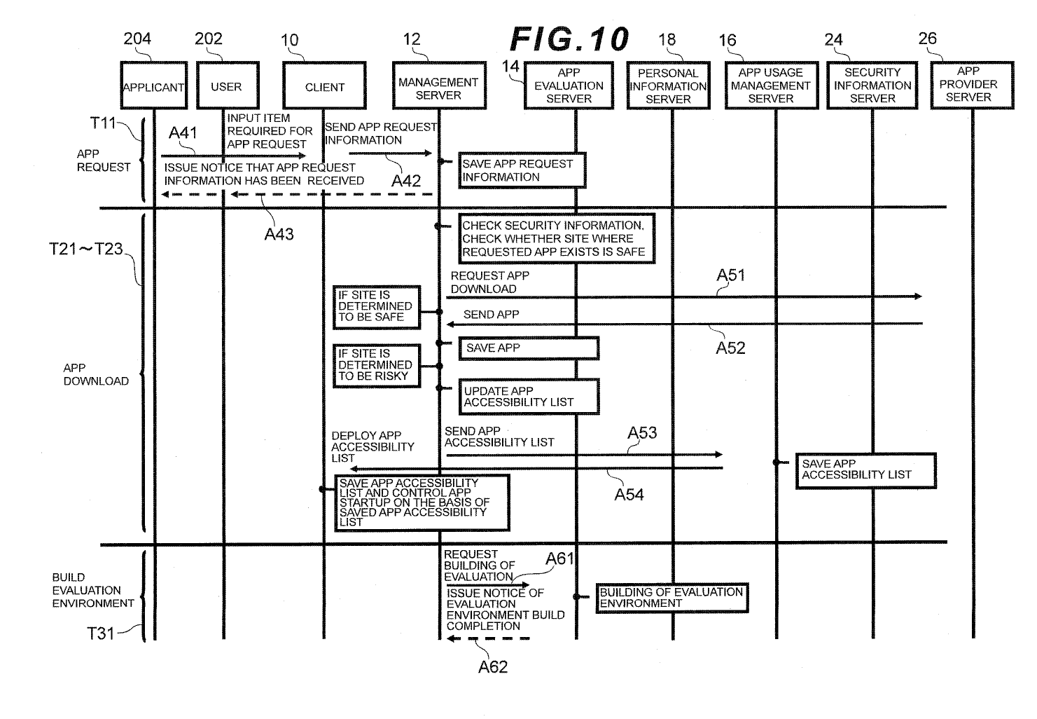

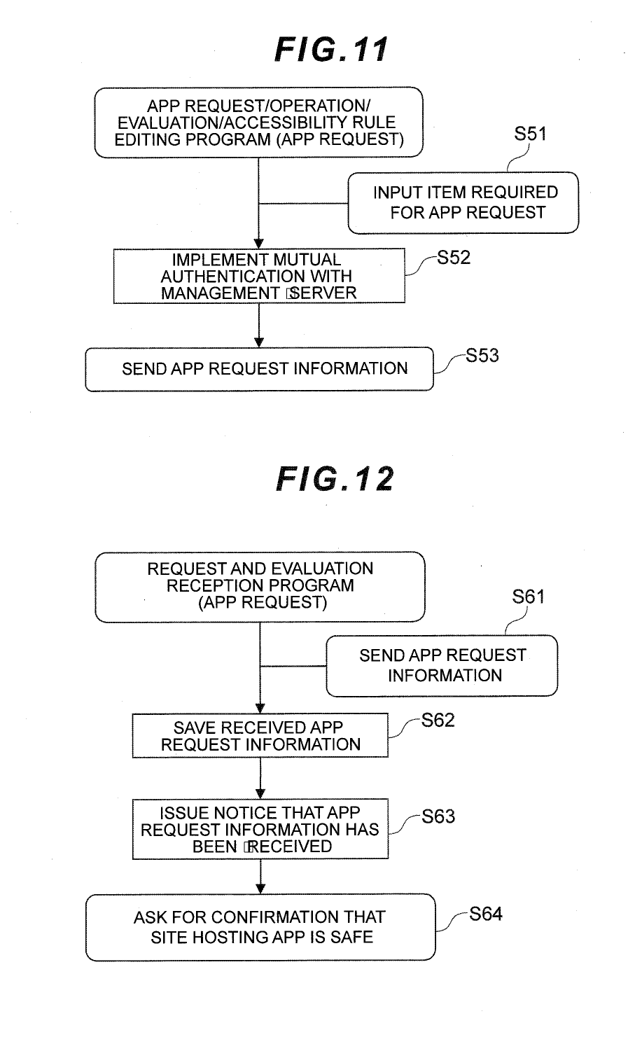

Processing at app request timing T11, app download timing T21 to T23, and evaluation timing build timing T31 will be described next in accordance with the time chart of FIG. 10 and the flowcharts of FIGS. 11 to 22.

When an item required for an app request is first input by the applicant 204 at the app request timing T11 (A41), the client 10 performs mutual authentication processing with the management server 12, and on condition that authentication is successful, sends app request information to the management server 12 (A42). At this time, the management server 12 receives the app request information from the client 10, saves the received app request information in the memory 52, and notifies the client 10 and the applicant 204 that the app request information has been received (A43).

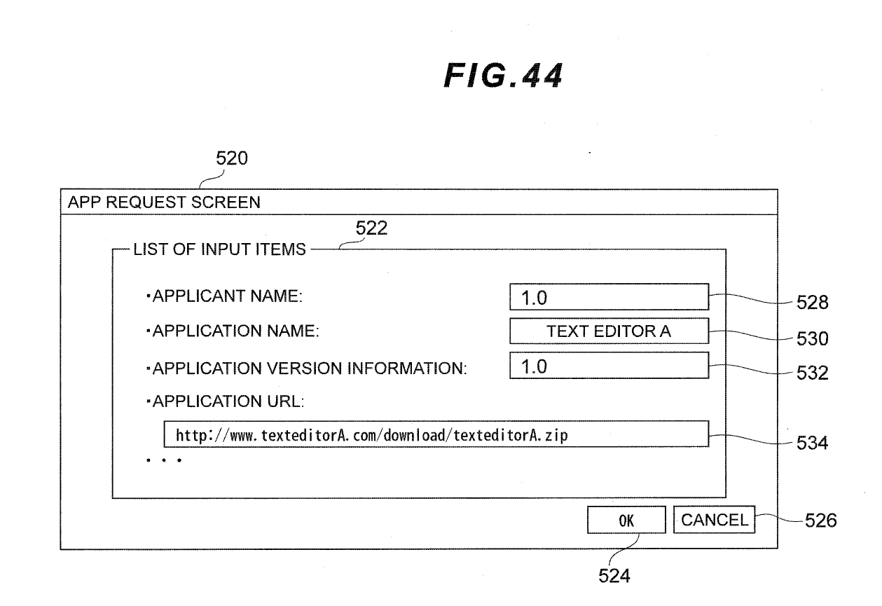

FIG. 44 shows an example of an app request screen 520. The app request screen 520 displays an input item list display area 522, an OK button 524, and a cancel button 526.

The input item list display area 522 displays an applicant name 528, an application name 530, application version information 532, and an application URL 534. Note, however, that not all the items in the list of input items are necessarily required.

Thereafter, at app download timing T21 to T23, the management server 12 starts the processing by starting up the determination/app accessibility list management program 62, checks the security information 80, determines whether the site hosting the requested app is safe, and when the site is determined to be safe, requests an app download from the app provider server 26 (A51). Thereafter, an app is sent to the management server 12 from the app provider server 26 (A52), and the management server 12 saves the received app in the memory 52.

However, upon determining that the site is not safe, the management server 12 updates the app accessibility list 86 in accordance with the determination result, and sends the app accessibility list to the app usage management server 16 (A53).

The app usage management server 16 saves the app accessibility list 130 in the memory 122 and deploys the app accessibility list 130 to the client 10 (A54).

Here, when a site is risky, the processing ends, whereas if the site is safe, the client 10 executes processing to build an evaluation environment, evaluate the app, and collect information, and so forth, and saves the app accessibility list 46 in the memory 32, and controls the startup of the app on the basis of the saved app accessibility list 46.

Subsequently at timing T31 for building the evaluation environment, a request to build the evaluation environment is sent to the app evaluation server 14 from the management server 12 (A61). The app evaluation server 14 builds the evaluation environment in response to the request from the management server 12 and then notifies the management server 12 that the building of the evaluation environment is complete (A62).

The processing at app request timing T11 will be explained next with reference to the flowchart of FIG. 11.

The CPU 30 of the client 10 first starts the processing by starting up the app request/operation/evaluation/accessibility rule editing program 40, and when an item required for an app request is input by the applicant 204 (S51), the CPU 30 responds by performing mutual authentication processing with the management server 12 (S52).

The CPU 30 of the client 10 sends app request information to the management server 12 on condition that the authentication is successful (S53).

At this time, the CPU 50 of the management server 12 starts up the request and evaluation reception program 60 as shown in FIG. 12, executes processing to receive app request information from the client 10 (S61), saves the received app request information in the memory 52 (S62), notifies the client 10 and the applicant 204 that the app request information has been received (S63), and issues a safety check request for the site hosting the app to the determination/app accessibility list management program 62 (S64).

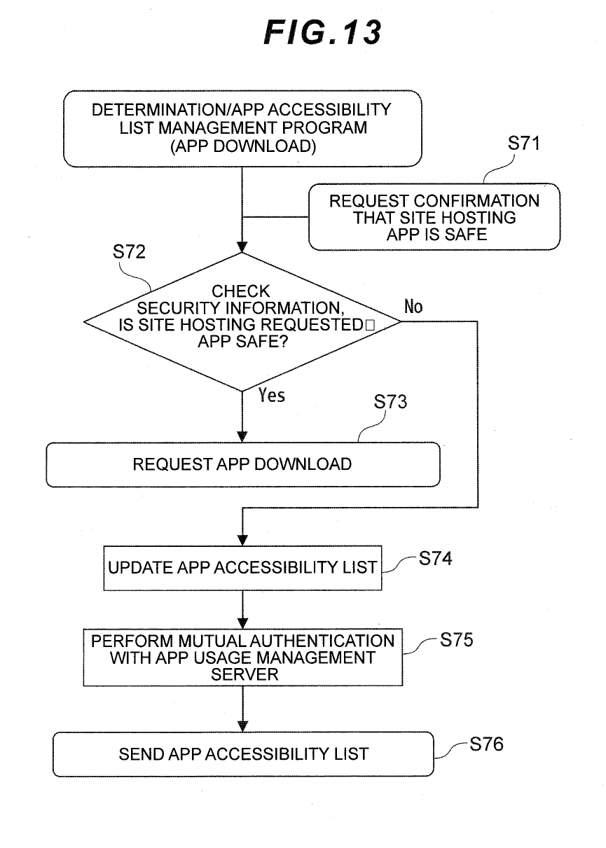

Thereafter, at app download timing T21 to T23, as shown in FIG. 13, the CPU 50 in the management server 12 starts the processing by starting up the determination/app accessibility list management program 62, inputs a safety check request for the site hosting where the app (S71), checks the security information 80 in response to this input, determines whether the site hosting the requested app is safe (S72), and when the site is determined to be safe, requests an app download from the security information/app acquisition program 64 (S73).

An app download is thus requested by the management server 12 from the app provider server 26. Thereafter, an app is sent to the management server 12 from the app provider server 26, and the CPU 50 of the management server 12 saves the app in the memory 52.

However, when it is determined in step S72 that the site is not safe, the CPU 50 updates the app accessibility list 86 in accordance with the determination result, performs mutual authentication processing with the app usage management server 16 (S75), and on condition that the authentication is successful, sends the app accessibility list to the app usage management server 16 (S76).

The app usage management server 16 then saves the app accessibility list 130 in the memory 122 and deploys the app accessibility list 130 to the client 10.

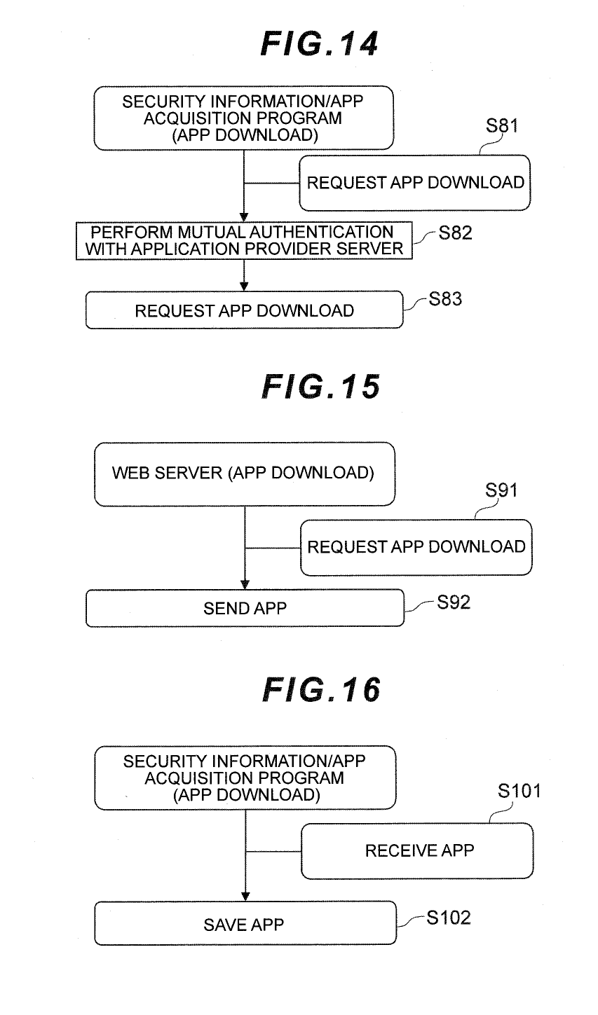

Thereafter, when an app download is requested by the management server 12 from the app provider server 26, as shown in FIG. 14, the CPU 50 starts up the security information/app acquisition program 64, inputs an app download request (S81), performs mutual authentication processing with the app provider server 26 (S82) and on condition that authentication is successful, requests an app download from the app provider server 26 (S83).

Here, in the app provider server 26, as shown in FIG. 15, the Web server 190 inputs an app download request (S91) and sends the app to the management server 12 (S92).

Thereafter, as shown in FIG. 16, the CPU 50 of the management server 12 receives the app from the Web server 190 (S101) and saves the received app in the memory 52 (S102).

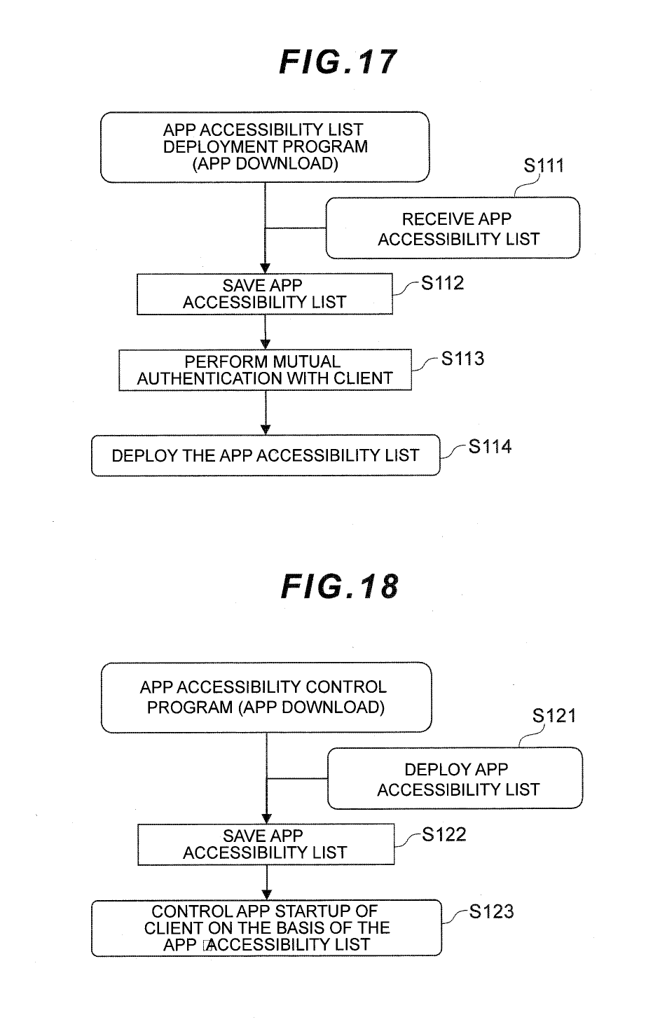

Meanwhile, as shown in FIG. 17, the CPU 120 in the app usage management server 16 begins processing by starting up the app accessibility list deployment program 134, receives the app accessibility list 130 (S111), saves the received app accessibility list 130 in the memory 122 (S112), performs mutual authentication processing with the client 10 (S113), and on condition that authentication is successful, deploys the app accessibility list 130 to the client 10 (S114).

Meanwhile, as shown in FIG. 18, the CPU 10 in the client 10 starts up the app accessibility control program 42, inputs the app accessibility list 130 deployed by the app usage management server 16 (S121), saves the app accessibility list 46 in the memory 32 (S122), controls startup of the app in the client 10 on the basis of the saved app accessibility list 46 (S123).

Subsequently, at timing T31 for building the evaluation environment, a request to build the evaluation environment is sent to the app evaluation server 14 from the management server 12, the evaluation environment is built in the app evaluation server 14, and a notice regarding evaluation environment build completion is sent from the app evaluation server 14 to the management server 12.

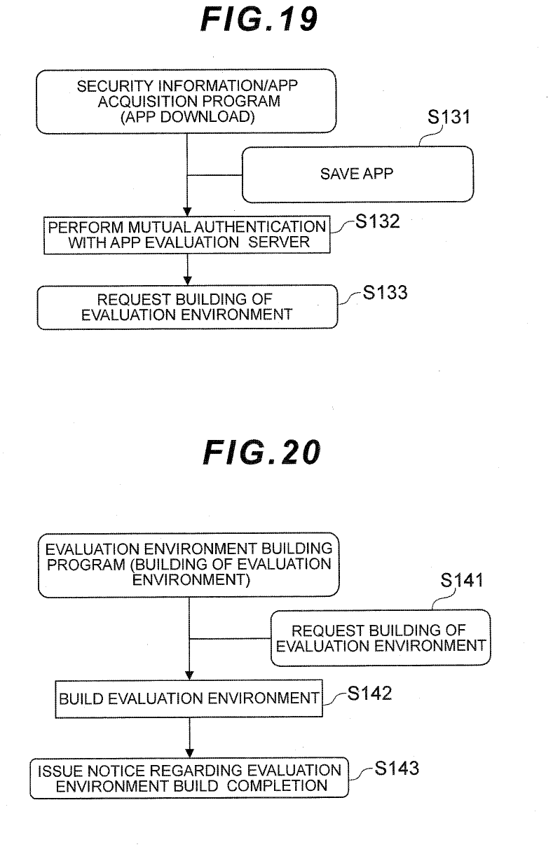

More specifically, as shown in FIG. 19, the CPU 50 in the management server 12 begins processing by starting up the security information/app acquisition program 64, saves the app in the memory 52 (S131), performs mutual authentication processing with the app evaluation server 14 (S132), and on condition that authentication is successful, requests that the app evaluation server 14 build the evaluation environment (S133).

Meanwhile, as shown in FIG. 20, the CPU 90 in the app evaluation server 14 begins processing by starting up the evaluation environment building program 102, inputs a request to build the evaluation environment from the management server 12 (S141), builds the evaluation environment in response to the request thus input (S142), and issues a notice regarding evaluation environment build completion to the management server 12 (S143). In the building of the evaluation environment, a VM environment is built and the app is introduced. Here, if such an environment has already been built and an app introduced, it is unnecessary to build a VM environment.

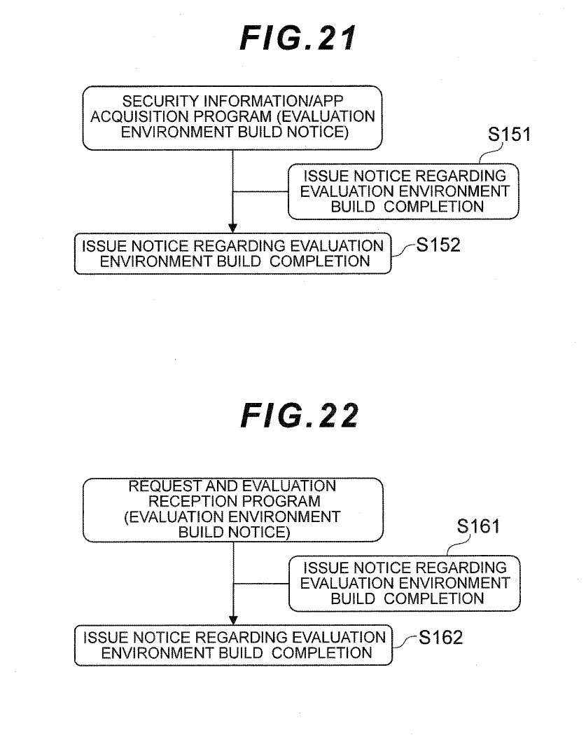

Meanwhile, as shown in FIG. 21, the CPU 50 in the management server 12 starts up the security information/app acquisition program 64, inputs the notice regarding evaluation environment build completion from the app evaluation server 14 (S151), and issues a notice regarding evaluation environment build completion to the request and evaluation reception program 60 in response to this input notice (S152).

Thereafter, as shown in FIG. 22, the CPU 50 begins processing by starting up the request and evaluation reception program 60, inputs the notice regarding evaluation environment build completion (S161), and issues a notice regarding evaluation environment build completion (evaluation is possible) to the client 10 in response to the notice thus input (S162).

Note that although this notice is sent to all the clients 10 in the aforementioned processing, notification may also be made using mail or the like, or a Web server program may be prepared on the management server 12 and published using this Web server program.

At app request timing T11, as shown in FIG. 9, the client 10 is used as communication request source device 304; the management server 12 is used as communication request destination device 306; the app request/operation/evaluation/accessibility rule editing program 40 is used as the communication request source program 308, and the request and evaluation reception program 60 is used as the communication request destination program 310.

Furthermore, at app download timing T21 to T23, the management server 12 and the app usage management server 16 are used as the communication request source device 304; the management server 12, the app usage management server 16, and the client 10 are used as the communication request source device 306; the security information/app acquisition program 64, the determination/app accessibility list management program 62, and the app accessibility list deployment program 134 are used as the communication request source program 308, and the request and evaluation reception program 60, the Web server 190, and the app accessibility control program 42 are used as the communication request destination program 310.

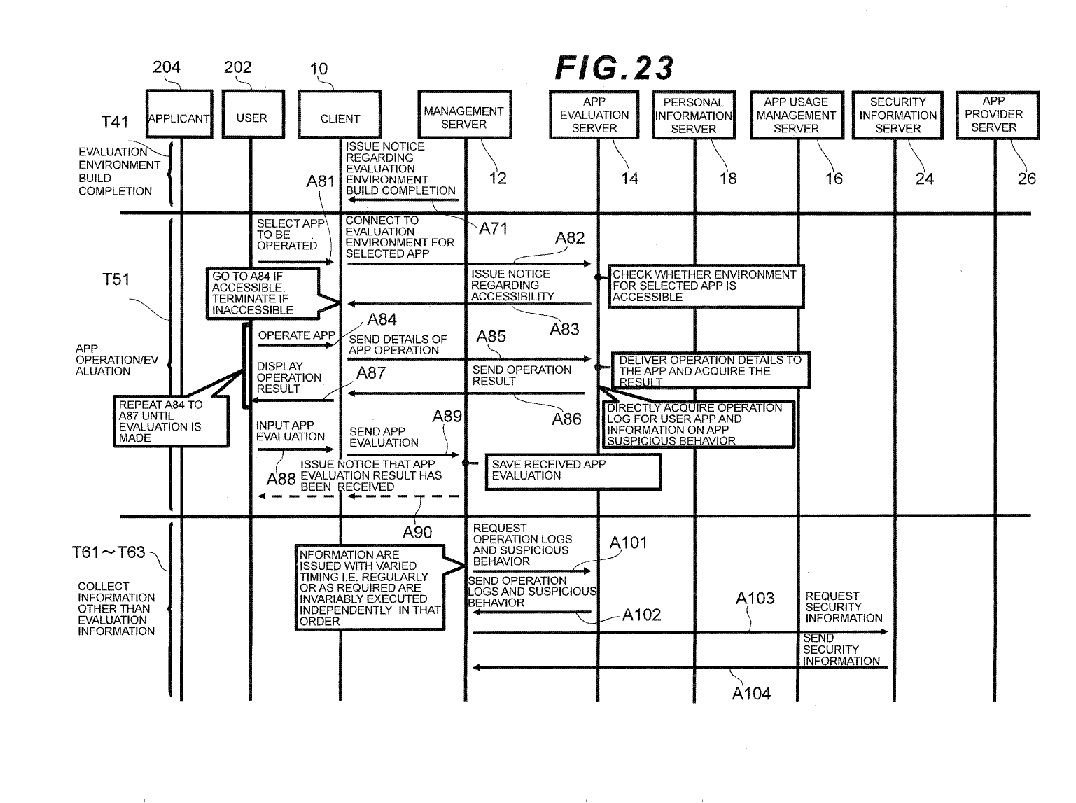

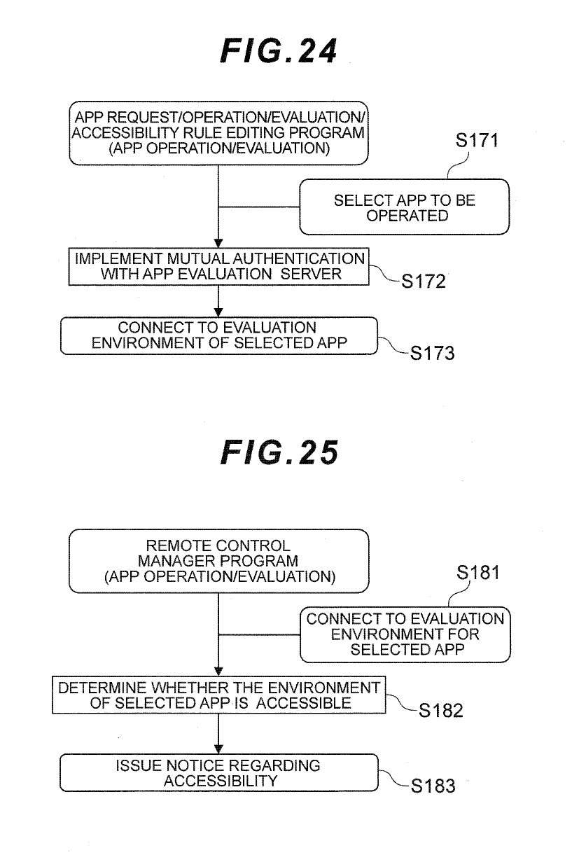

The processing at evaluation environment build completion timing T41, app operation/evaluation timing T51, and timing T61 to T63 for collecting information other than evaluation information will be explained next with reference to the time chart of FIG. 23 and the flowcharts of FIGS. 24 to 34.

Foremost, at evaluation environment build completion timing T41, a notice that evaluation environment building is complete is sent to the client 10 from the management server 12 (A71).

Thereafter, at the app operation/evaluation timing T51, the user 202 selects an app that is to be operated from the client 10. The client 10 connects to the evaluation environment for the selected app, on the app evaluation server 14 (A82). Here, the app evaluation server 14 checks whether or not the environment for the selected app is accessible and, as a result of this check, notifies accessibility to the client 10 (A83).

Here, if the app is accessible, the client 10 performs processing to evaluate the app and if the app is not accessible, terminates the processing.

When the app is accessible, the user 202 performs an app operation on the client 10 (A84), and the client 10 sends details of the app operation to the app evaluation server 14 (A85). The app evaluation server 14 delivers the operation details to the app, and acquires and sends the result to the management server 12 (A86).

The client 10 displays the operation result to the user 202 (A87). The processing of A84 to A87 is subsequently repeated until an evaluation is conducted.

After the evaluation has been conducted on the app, the user 202 inputs the app evaluation to the client 10 (A88), and the client 10 sends the app evaluation to the management server 12 (A89). The management server 12 saves the received app evaluation in the memory 52 and then notifies the client 10 that the app evaluation result has been received and notifies the user 202 (A90).

The specific processing at app operation/evaluation timing T51 will be explained next with reference to the flowcharts of FIGS. 24 to 34. The CPU 30 of the client 10 first starts up the app request/operation/evaluation/accessibility rule editing program 40, receives a selection of an app to be operated by the user 202 (S171), performs mutual authentication processing with the app evaluation server 14 (S172), and on condition that authentication is successful, connects to the evaluation environment build of the selected app on the app evaluation server 14 (S173).

Thereafter, as shown in FIG. 25, the CPU 90 in the app evaluation server 14 starts up the remote control manager program 116, inputs processing to connect to the evaluation environment of the selected app (S181), determines whether or not the environment of the selected app is accessible, and, as a result of this determination, notifies accessibility to the client 10 (S183).

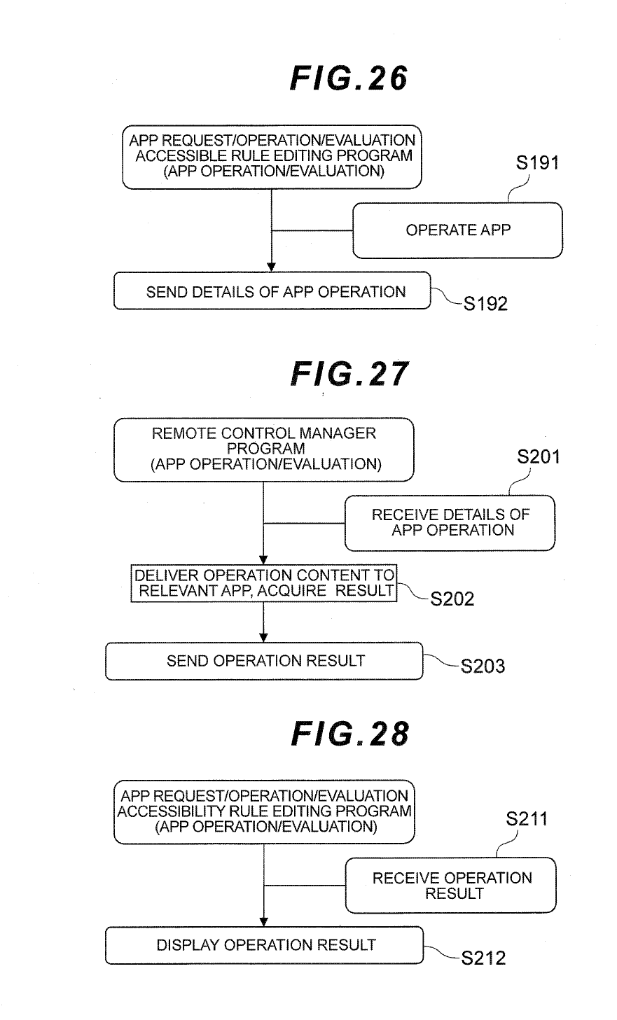

Meanwhile, as shown in FIG. 26, the CPU 30 of the client 10 starts up the app request/operation/evaluation/accessibility rule editing program 40, receives the app operation from the user 202 (S191), and sends details of the app operation to the app evaluation server 14 (S192).

As shown in FIG. 27, the CPU 90 in the app evaluation server 14 starts up the remote control manager program 116, receives the app operation details (S201), delivers the received operation details to the app and acquires the result (S202), and sends the operation result to the client 10 (S203).

Furthermore, as shown in FIG. 28, the CPU 30 in the client 10 starts up the app request/operation/evaluation/accessibility rule editing program 40, receives the operation result (S211), and displays the received operation result to the client 10 (S212).

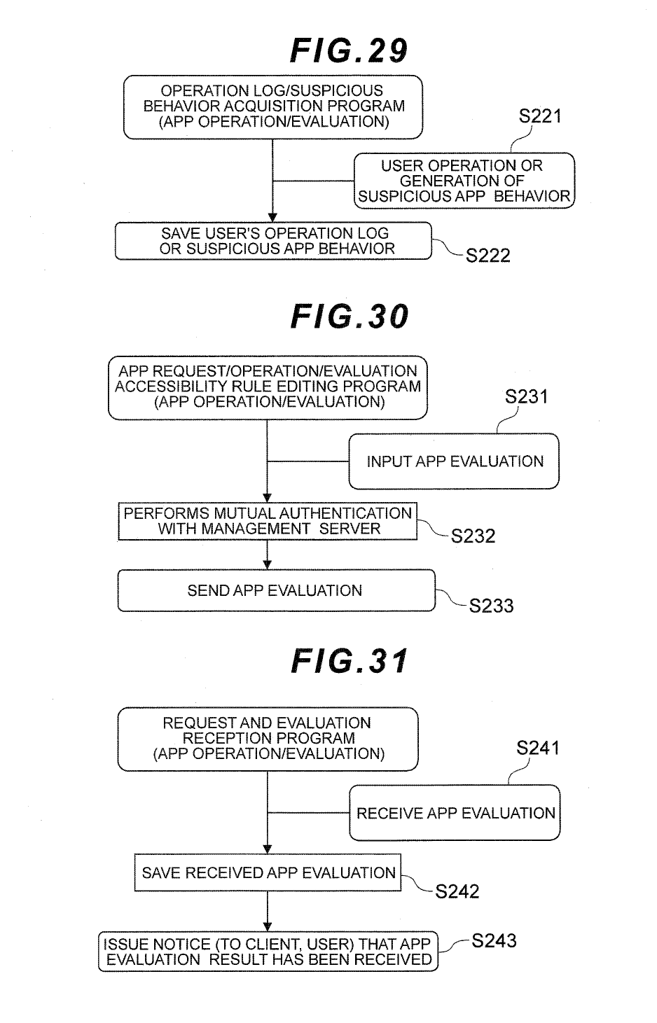

Meanwhile, as shown in FIG. 29, the CPU 90 in the app evaluation server 14 starts up the operation log/suspicious behavior acquisition program 112, inputs user operations or instances of suspicious app behavior (S221), and saves user operation logs or suspicious app behavior in the memory 92 (S222).

Furthermore, as shown in FIG. 30, the CPU 30 in the client 10 starts up the app request/operation/evaluation/accessibility rule editing program 40, receives an app evaluation input from the user 202 (S231), performs mutual authentication processing with the management server 12 (S232), and on condition that authentication is successful, sends an app evaluation to the management server 12 (S233).

As shown in FIG. 31, the CPU 50 in the management server 12 starts up the request and evaluation reception program 60, receives the app evaluation from the client 10 (S241), saves the received app evaluation in the memory 52 (S242), and notifies the client 10 and the user 202 that the app evaluation result has been received (S243).

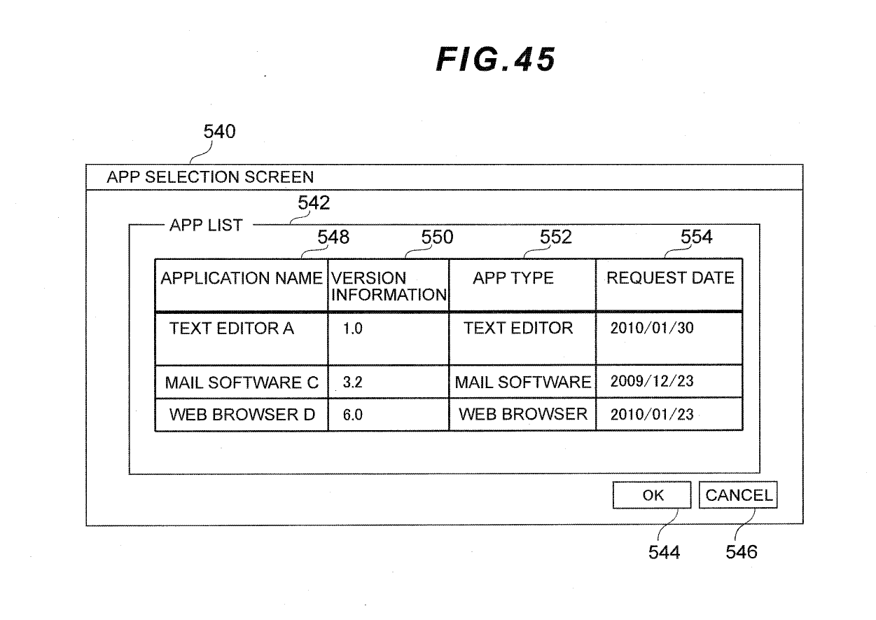

FIG. 45 shows a display example of an app selection screen 540.

The app selection screen 540 comprises an app list display area 542, an OK button 544, and a cancel button 546.

The app list display area 542 displays an application name 548, version information 550, an app type 552, and a request date 554. Here, the user 202 is able to display a list of apps that can be operated/evaluated in the app list display area 542 and therefore select an app that the user would like to operate/evaluate.

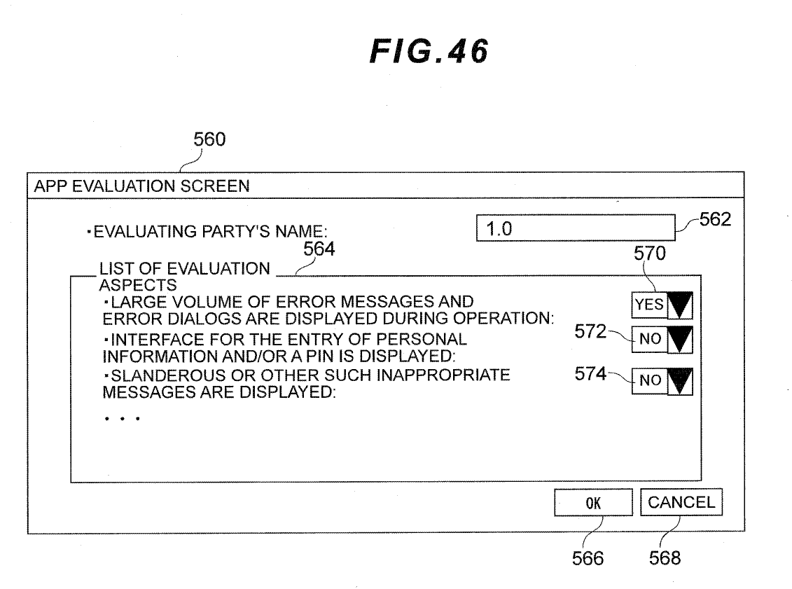

FIG. 46 shows a display example of an app evaluation screen 560.

The app evaluation screen 560 comprises an evaluating party's name display area 562, an evaluation aspect list display area 564, an OK button 566, and a cancel button 568.

The evaluating party's name display area 562 displays the ‘evaluating party's name’ of the person evaluating the application, and the evaluation aspect list display area 564 displays items such as ‘a large volume of error messages or error logs are displayed during operation,’ ‘an interface for the entry of personal information and/or a PIN is displayed,’ and ‘slanderous or other such inappropriate messages are displayed.’ For each of these items, when the evaluation reveals reasonability, ‘YES’ is correspondingly input to the input areas 570, 574, and 574 for inputting an evaluation of each aspect, and ‘NO’ is input when the evaluation is such that no reasonability exists.

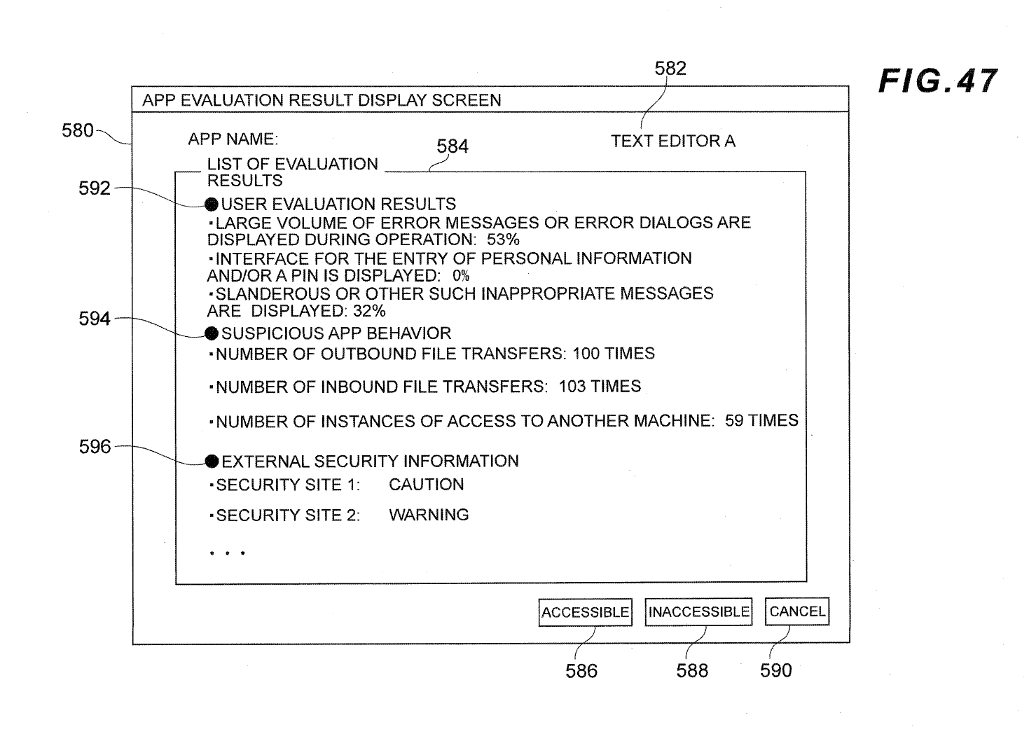

FIG. 47 shows a display example of an app evaluation result display screen 580.

The app evaluation result display screen 580 comprises an app name display area 582, an evaluation result list display area 584, an accessible button 586, an inaccessible button 588, and a cancel button 590.

The app name display area 582 displays ‘app name’, and the evaluation result list display area 584 displays information relating to a user evaluation result 592, suspicious app behavior 594, and external security information 596.

For example, as the user evaluation result 592, ‘53%’ is displayed for ‘a large volume of error messages or error dialogs are displayed during operation,’ ‘0%’ is displayed for ‘an interface for the entry of personal information and/or a PIN is displayed,’ and ‘32%’ is displayed for ‘slanderous or other such inappropriate messages are displayed.’

As suspicious app behavior 194, for example, ‘100 times’ is displayed for the ‘the number of outbound file transfers’, ‘103 times’ is displayed for ‘the number of inbound file transfers’, and ‘59 times’ is displayed for ‘the number of instances of access to another machine.’

As external security information 596, ‘caution’ is displayed for ‘security site 1’ and ‘warning’ is displayed for ‘security site 2,’ for example. Note that those items that are not configured as app accessibility rules are not displayed in the app evaluation result display screen 582. Furthermore, when a determination is to be deferred, the user selects the cancel button 590.

Note that ultimately determination processing is implemented automatically. However, instead of the determination being automatic, an app evaluation result display screen may be displayed to allow the system administrator to make a determination manually each time if he so chooses. Furthermore, when making a determination manually, the system administrator is also able to defer the determination regarding accessibility, and in this case select the cancel button.

Subsequently at timing T61 to T63 for collecting information other than evaluation information, as shown in FIG. 23, the management server 12 outputs operation logs and suspicious behavior requests to the app evaluation 14 regularly or with optional timing (A101). The app evaluation server 14 sends information relating to the operation logs and suspicious behavior to the management server 12 (A102).

Furthermore, the management server 12 outputs security information requests to the security information server 24 (A103) and, in response to the request from the management server 12, the security information server 24 sends security information to the management server 12 (A104).

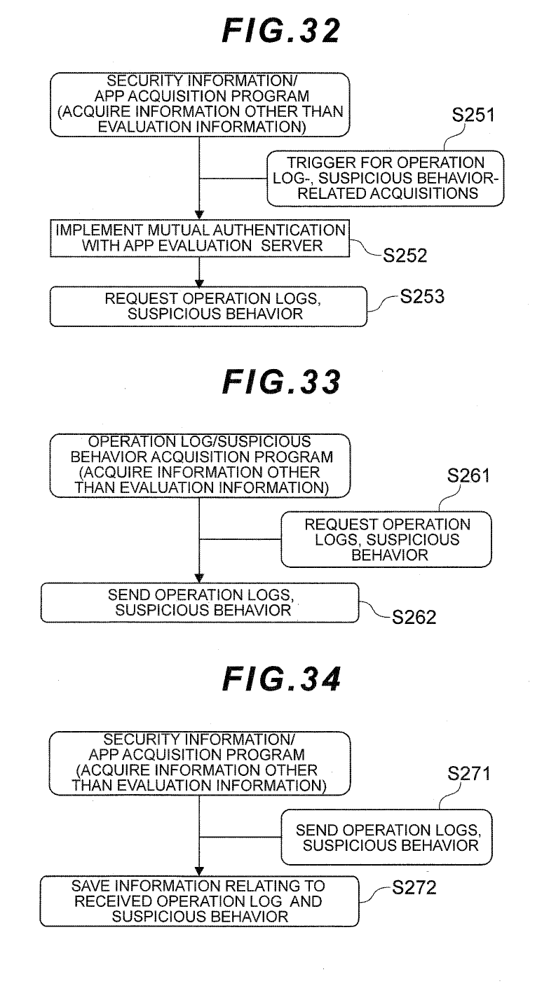

As shown in FIG. 32, at the timing for collecting information other than evaluation information, the CPU 50 of the management server 12 starts up the security information/app acquisition program 64 and, with the operation log- and suspicious behavior-related acquisitions by the management server itself serving as a trigger (S251), the CPU 50 implements mutual authentication with the app evaluation server 14 (S252), and on condition that authentication is successful, requests operation logs and suspicious behavior from the app evaluation server 14 (S253).

Meanwhile, as shown in FIG. 33, the CPU 90 in the app evaluation server 14 starts up the operation log/suspicious behavior acquisition program 112, receives the request for operation logs and suspicious behavior (S261), and in response to the request, sends operation logs and suspicious behavior to the management server 12 (S262). Thereafter, as shown in FIG. 34, the CPU 50 in the management server 12 starts up the security information/app acquisition program 64, receives information relating to operation logs and suspicious behavior from the app evaluation server 14 (S271), and saves the received information relating to operation logs and suspicious behavior in the memory 52 (S272).

At app operation/evaluation timing T51, as shown in FIG. 9, the client 10 is used as communication request source device 304; the app evaluation server 14 is used as communication request destination device 306; the app request/operation/evaluation/accessibility rule editing program 40 is used as the communication request source program 308, and a request and evaluation reception program 60 is used as the communication request destination program 310.

Furthermore, at timing T61 to T63 for collecting information other than evaluation information, the management server 12 is used as the communication request source device 304; the app evaluation server 14 and the security information server 24 are used as the communication request source device 306; the security information/app acquisition program 64 and the security information/app acquisition program 64 are used as the communication request source program 308, and the operation log/suspicious behavior acquisition program 112 are used as the communication request destination program 310.

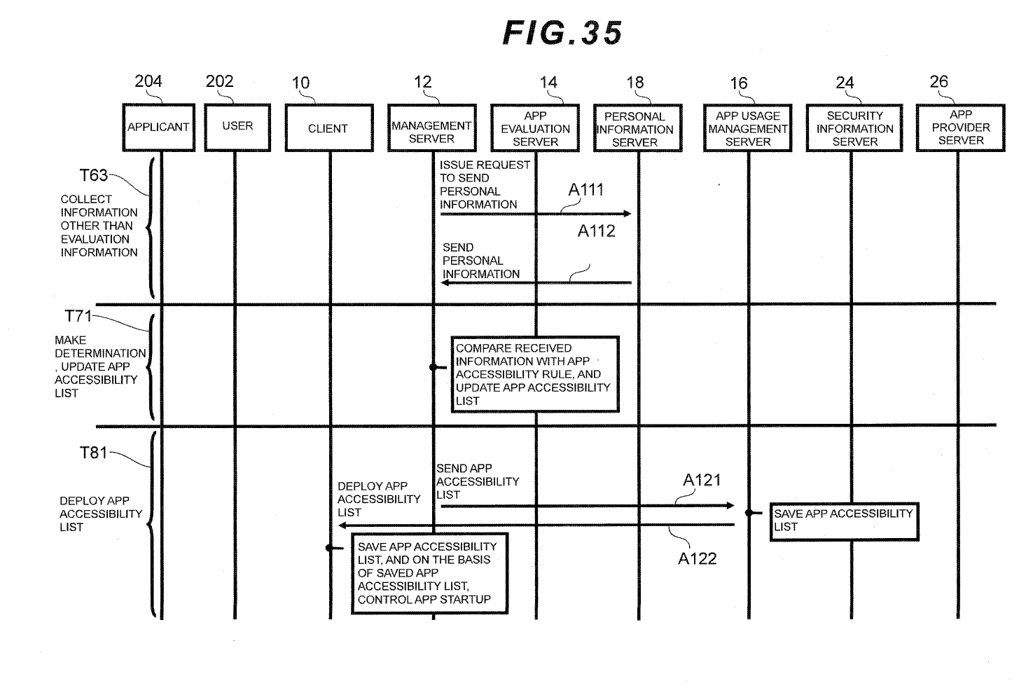

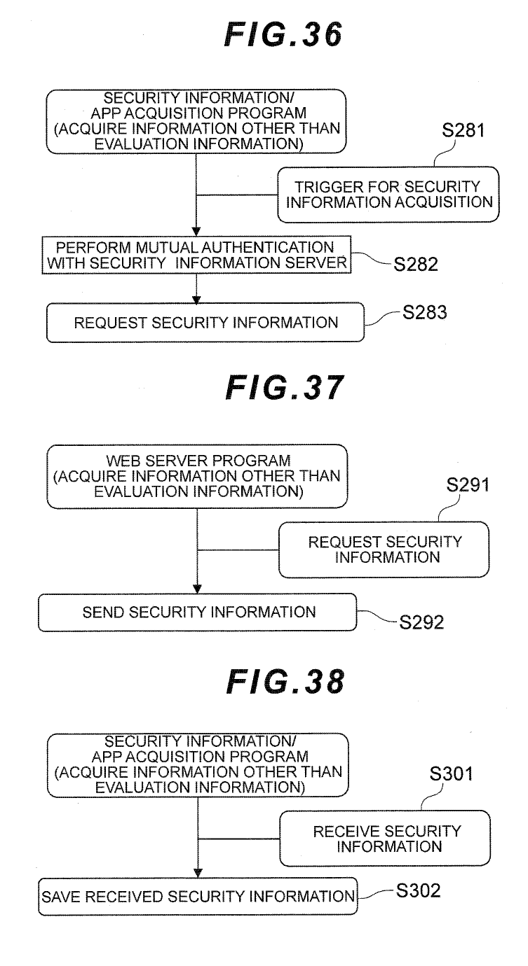

The processing at the timing T63 for collecting information other than the evaluation information, the timing for updating the app accessibility list, and the timing for deploying the app accessibility list will be explained next with reference to the time chart of FIG. 35 and the flowcharts of FIGS. 36 to 42.

First, at the timing T63 for collecting information other than the evaluation information, the management server 12 requests that the personal information server 18 send personal information (A111), the personal information server 18 sends personal information to the management server 12 in response to the request from the management server 12 (A112).

Meanwhile, at the timing T71 for making a determination and updating the app accessibility list, the management server 12 compares the received information with the app accessibility rule 72 at the timing for receiving an app evaluation from the client 10, the timing for receiving security information from the security information server 24 and the timing for receiving operation logs and/or suspicious behavior from the app evaluation server 14 or the timing for receiving personal information from the personal information server 18, and updates the content of the app accessibility list 86 in accordance with the comparison result.

Furthermore, at the timing T81 for deploying the app accessibility list, the management server 12 sends the app accessibility list to the app usage management server 16 (A121). The app usage management server 16 saves the received app accessibility list 130 to the memory 122, and deploys the app accessibility list to the client 10 (A122).

The client 10 saves the app accessibility list 46 and controls the startup of the app on the basis of the saved app accessibility list 46.

As shown in FIG. 36, at the timing T63 for collecting information other than evaluation information, the CPU 50 of the management server 12 starts up the security information/app acquisition program 64 and, with the acquisition of security information by the management server itself serving as a trigger (S281), the CPU 50 implements mutual authentication processing with the security information server 24 (S282), and on condition that authentication is successful, outputs a security information request to the security information server 24 (S283).

As shown in FIG. 37, in response to requests from the management server 12, the security information server 24 starts up the program of the Web server 172, receives a security information request (S291), and sends the security information 166 to the management server 12 (S292).

As shown in FIG. 38, the CPU 50 in the management server 12 starts up the security information/app acquisition program 64, receives security information from the security information server 24 (S301), and saves the received security information in the memory 52 (S302).

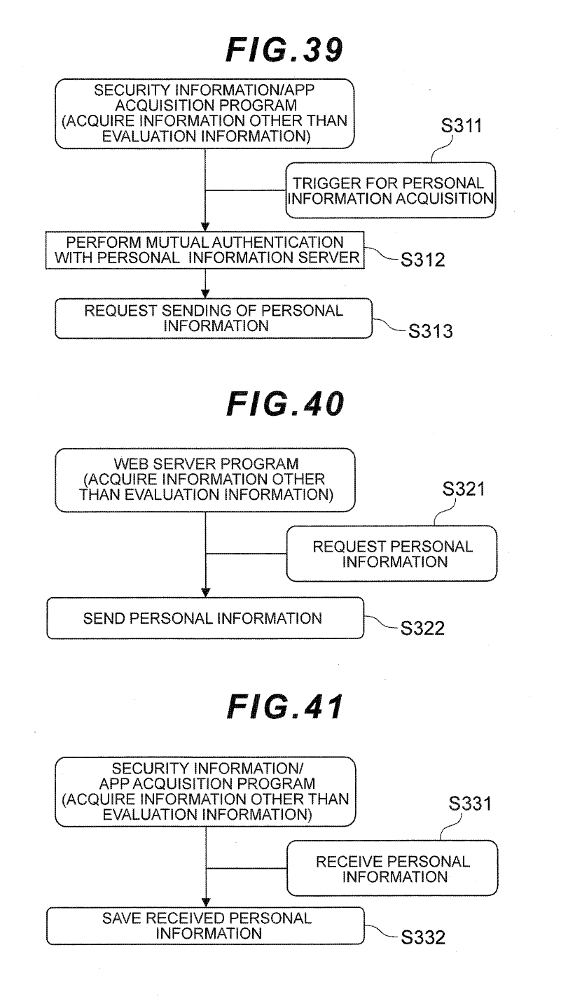

Furthermore, as shown in FIG. 39, the CPU 50 in the management server 12 starts up the security information/app acquisition program 64, takes personal information acquisitions by the management server itself as a trigger (S311), implements mutual authentication processing with the personal information server 18 (S312), and on condition that authentication is successful, requests that the personal information server 18 send the personal information (S313).

Meanwhile, as shown in FIG. 40, the personal information server 18 starts up the Web server 154, receives a personal information request from the management server 12 (S321) and sends the personal information 148 to the management server 12 (S320).

As shown in FIG. 41, the CPU 50 of the management server 12 starts up the security information/app acquisition program 64, receives personal information from the personal information server 18 (S331), and saves the received personal information 82 in the memory 52 (S332).

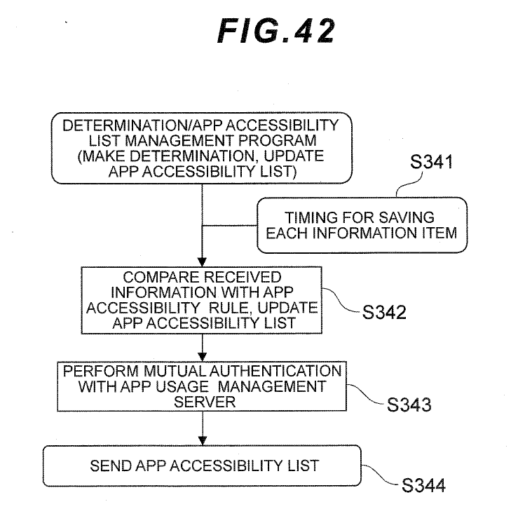

Thereafter, at the timing T71 for making a determination and updating the app accessibility list, as shown in FIG. 42, the CPU 50 of the management server 12 starts up the determination/app accessibility list management program 62, starts processing at the timing saved at the timing for collecting information other than the evaluation information (S341), compares the received information with the app accessibility rule 70, updates the accessibility list 86 in accordance with the comparison result (S342), performs mutual authentication processing with the app usage management server 16 (S343), and on condition that authentication is successful, sends the updated app accessibility list 86 to the app usage management server 16 (S344).

At the timing T81 for deploying the app accessibility list, as shown in FIG. 9, the management server 12 is used as the communication request source device 304; the app usage management server 16 is used as the communication request destination device 306; the determination/app accessibility list management program 66 is used as the communication request source program 308, and the app accessibility list deployment program 134 is used as the communication request destination program 310.

According to the present embodiment, the management server 12 is capable of building a safe application evaluation environment that is provided to the client 10, determining the accessibility of applications based on an evaluation result collected from the client 10, and providing the determination result to the client 10. Furthermore, according to this embodiment, the system administrator's work load is lightened in that the system administrator does not perform the work involved in allowing usage of an application, namely, the work of receiving application usage requests, investigating and evaluating applications, and allowing usage thereof, for example, thereby enabling the user to evaluate the application easily and safely since the safe environment that is required to evaluate the application is prepared automatically.

In addition, according to this embodiment, upon using the information collected from internal and external sources prior to building the application evaluation environment or determining application accessibility, should a problem arise with application usage at this point, the processing can be terminated without performing subsequent work, thereby obviating the need to perform extra work and enabling a reduction in work-related costs.

### REFERENCE SIGNS LIST

10 Client (Client terminal)
12 Management server
14 App evaluation server
16 App usage management server
18 Personal information server
20 Network
22 Internet
24 Security information server
26 Application provider server
30 CPU
32 Memory
48 Device authentication program
40 App request/operation/evaluation/accessibility rule editing program
42 App accessibility control program
46 App accessibility list
50 CPU
52 Memory
60 Request and evaluation reception program
62 Determination/App accessibility list management program
64 Security information/app acquisition program
66 App accessibility rule management program
90 CPU
92 Memory
102 evaluation environment building program
104 VM program
112 Operation log/suspicious behavior acquisition program
116 Remote control manager program
122 Memory
134 App accessibility list deployment program
140 CPU
142 Memory

1. A management system, comprising:
a management server that is coupled via a network to a security information server for storing security information and an application provider server for providing applications; and
one or more client terminals coupled via the network to the management server,
wherein the management server managing accessibility to the applications by exchanging information with each of the client terminals,
wherein the client terminals each request usage, from the management server, of an application that is provided by the application provider server,
wherein, in response to the request from each of the client terminals, the management server compares information specifying the source of the application requested in the request with external security information that is acquired from the security information server,
wherein, on condition that there is no problem with the safety of the source of the application requested in the request, the management server acquires the application requested in the request from the application provider server, builds a safe application evaluation environment for the acquired application and provides the environment to each of the client terminals, and
wherein, when an evaluation result for the acquired application is input from each of the client terminals, the management server compares accessibility determination information including the input evaluation result with an application accessibility rule that is received from any of the client terminals, determines the accessibility of the acquired application, and sends the determination result to each of the client terminals.

2. A management system according to claim 1,
wherein the accessibility determination information includes at least one information item among information indicating a security check result for the acquired application, information indicating an operation log for the acquired application, information indicating what is inappropriate and unnecessary access for the acquired application, personal information of each of the users, and external security information obtained from the network.

3. A management system according to claim 2,
wherein the management server acquires, as external security information, application vulnerability information, inappropriate site information, and inappropriate application information from the security information server.

4. A management system according to claim 3,
wherein the management server builds a safe application evaluation environment for the acquired application only if information relating to a basic software type or version for running the acquired application does not satisfy a condition prescribed by the application vulnerability information among the information belonging to the external security information, and
wherein the management server determines that the acquired application is inaccessible without building a safe application evaluation environment for the acquired application if the information relating to the basic software type or version satisfies the condition prescribed by the application vulnerability information.

5. A management system according to claim 4,
wherein, when the management server is coupled to an application evaluation server via the network and the application requested in the request is acquired from the application provider server, the management server asks the application evaluation server to build a safe application evaluation environment for the acquired application and provides the safe application environment evaluation environment built by the application evaluation server to each of the client terminals.

6. A management system according to claim 5,
wherein, when the management server is coupled to an application usage management server via the network and determines the accessibility of the acquired application, the management server sends the determination result to the application usage management server, and
wherein, upon receiving the determination result sent from the management server, the application usage management server updates an application accessibility list for storing accessibility information of one or more applications to be used by each of the users on the basis of the received determination result, and sends the updated application accessibility list to each of the client terminals.

7. An information processing method of a computer system that comprises a management server that is coupled via a network to a security information server for storing security information and an application provider server for providing applications, and one or more client terminals coupled via the network to the management server, the management server being coupled to an application evaluation server and an application usage management server via the network,
the method comprising:
by the client terminals each:
requesting usage of an application that is provided by the application provider server, to the management server;
by the management server:
in response to the request from each of the client terminals, comparing information specifying the source of the application requested in the request with external security information that is acquired from the security information server;
on condition that there is no problem with the safety of the source of the application requested in the request on the basis of the comparison result, acquiring the application requested in the request from the application provider server, and builds a safe application evaluation environment for the acquired application and provides the environment to each of the client terminals;
when an evaluation result for the acquired application is input from each of the client terminals, comparing accessibility determination information including the input evaluation result with an application accessibility rule that is received from any of the client terminals;
determining the accessibility of the acquired application on the basis of the comparison result; and
sending the determination result to each of the client terminals.

8. An information processing method of a computer system according to claim 7,
wherein the accessibility determination information includes at least one information item among information indicating a security check result for the acquired application, information indicating an operation log for the acquired application, information indicating what is inappropriate and unnecessary access for the acquired application, personal information of each of the users, and external security information obtained from the network.

9. An information processing method of a computer system according to claim 8,
wherein the management server acquires, as external security information, application vulnerability information, inappropriate site information, and inappropriate application information from the security information server.

10. An information processing method of a computer system according to claim 9,
wherein the management server builds a safe application evaluation environment for the acquired application only if information relating to a basic software type or version for running the acquired application does not satisfy a condition prescribed by the application vulnerability information among the information belonging to the external security information, and
wherein the management server determines that the acquired application is inaccessible without building a safe application evaluation environment for the acquired application if the information relating to the basic software type or version satisfies the condition prescribed by the application vulnerability information.

11. An information processing method of a computer system according to claim 10,
wherein, upon acquiring the application requested in the request from the application provider server, the management server asks the application evaluation server to build a safe application evaluation environment for the acquired application, and provides the safe application evaluation environment built by the application evaluation server to each of the client terminals.

12. An information processing method of a computer system according to claim 11,
wherein the management server:
when determining the accessibility of the acquired application, sends the determination result to the application usage management server, and
wherein the application usage management server:
upon receiving the determination result sent from the management server, updates an application accessibility list for storing accessibility information of one or more applications to be used by each of the users on the basis of the received determination result; and
sends the updated application accessibility list to each of the client terminals.
